(19) United States
(12) Patent Application Publication
(10) Pub. No.: US 2017/0125995 A1
(43) Pub. Date: May 4, 2017

(54) ELECTRICITY STORAGE SYSTEM

(71) Applicant: Toyota Jidosha Kabushiki Kaisha, Toyota-shi, Aichi-ken (JP)

(72) Inventors: Yuji Nishi, Nagoya-shi Aichi-ken (JP); Yukinari Tanabe, Nagoya-shi Aichi-ken (JP); Hiromasa Tanaka, Okazaki-shi Aichi-ken (JP); Hiroyuki Kaiya, Toyota-shi Aichi-ken (JP); Takahiko Hirasawa, Toyota-shi Aichi-ken (JP); Junta Izumi, Nagoya-shi Aichi-ken (JP)

(73) Assignee: Toyota Jidosha Kabushiki Kaisha, Toyota-shi Aichi-ken (JP)

(21) Appl. No.: 15/313,155

(22) PCT Filed: May 28, 2015
(86) PCT No.: PCT/IB2015/000772

§ 371 Date: Nov. 22, 2016

(30) Foreign Application Priority Data
May 30, 2014 (JP) 2014-113598

(51) Int. Cl. H02H 1/00; H02J 7/00; H02H 3/087; H02J 7/34

(52) U.S. Cl. CPC H02H 1/0007; H02J 7/345; H02J 7/0063; H02H 3/087

(57) ABSTRACT

An electricity storage system includes an electricity storage device, a positive electrode line, a negative electrode line, a capacitor, at least two diodes, and a first intermediate line. The electricity storage device is able to supply power to a load. The electricity storage device includes at least two electricity storage groups connected in series. The electricity storage group includes at least two electricity storage elements connected in series. Each electricity storage element includes a current breaker. The capacitor is connected to the positive and negative electrode lines. At least two diodes are connected in series between the positive electrode line and the negative electrode line and are respectively connected in parallel to the electricity storage groups. The first intermediate line is connected between a first connection point at which the electricity storage groups are connected together and a second connection point at which the diodes are connected together.

### CROSS-REFERENCE TO RELATED APPLICATIONS

This application is a National Stage of International Application No. PCT/IB2015/000772 filed on May 28, 2015, which claims priority to Japanese Patent Application No. 2014-113598, filed May 30, 2014, the entire contents of which are hereby incorporated by reference.

### BACKGROUND

1. Field

The present disclosure relates to an electricity storage system which has an electricity storage device with a plurality of electricity storage elements connected in series, each electricity storage element including a current breaker.

2. Description of Related Art

In Japanese Patent No. 05333671, an intermediate line is provided in addition to a positive electrode line and a negative electrode line, whereby capacitors are respectively connected in parallel to two battery groups (first battery group and second battery group) connected in series. When the power of an assembled battery constituted by the two battery groups is not supplied to a load, the voltage value of each capacitor becomes the voltage value of the battery group connected in parallel to each capacitor.

### SUMMARY

For example, if the current breaker of a single battery included in the first battery group is activated, the voltage value of the first battery group is applied to the activated current breaker. In a configuration in which the intermediate line is omitted, when the current breaker is activated, the voltage value of the assembled battery is applied to the activated current breaker. In this way, in the configuration in which the intermediate line is provided, it is possible to decrease the voltage value to be applied to the activated current breaker compared to the configuration in which the intermediate line is omitted.

In Japanese Patent No. 05333671, when the power of the assembled battery is supplied to the load, and the current breaker of the single battery included in the first battery group is activated, only the power of the second battery group is supplied to the load. The voltage value of the capacitor (referred to as a second capacitor) connected in parallel to the second battery group becomes equal to the voltage value of the second battery group.

On the capacitor (referred to as a first capacitor) connected in parallel to the first battery group, an electric charge in a direction opposite to the second capacitor is accumulated. That is, if the voltage value of the second capacitor is “+Vc [V]”, the voltage value of the first capacitor becomes “−Vc [V]”. With this, the potential on the positive electrode terminal of the first battery group becomes “−Vc [V]”, and the potential on the negative electrode terminal of the first battery group becomes 0 [V].

With this, the total voltage value of the voltage value of the first battery group and the voltage value (the voltage value of the second battery group) Vc is applied to the activated current breaker. That is, the voltage value of the assembled battery is applied to the activated current breaker. Accordingly, in Japanese Patent No. 05333671, if the current breaker is activated when the power of the assembled battery is supplied to the load, it is not possible to decrease the voltage value to be applied to the activated current breaker.

According to an aspect, an electricity storage system includes an electricity storage device, a positive electrode line, a negative electrode line, a capacitor, at least two diodes, and a first intermediate line. The electricity storage device is able to supply power to a load. The electricity storage device includes at least two electricity storage groups connected in series. Each electricity storage group includes at least two electricity storage elements connected in series. Each electricity storage element includes a current breaker. The current breaker is configured to break a current path of the electricity storage element. The positive electrode line connects a positive electrode terminal of the electricity storage device to the load. The negative electrode line connects a negative electrode terminal of the electricity storage device to the load. The capacitor is connected to the positive electrode line and the negative electrode line. At least two diodes are connected in series between the positive electrode line and the negative electrode line and are connected in parallel to the electricity storage groups. A cathode of each diode is connected to a positive electrode terminal of each electricity storage group. An anode of each diode is connected to a negative electrode terminal of each electricity storage group. The first intermediate line is connected between a first connection point and a second connection point. At the first connection point, the electricity storage groups are connected together. At the second connection point, the diodes are connected together.

In the above-described aspect, when the current breaker of the electricity storage element included in the electricity storage group is activated, the electricity storage group not including the activated current breaker can be discharged using the first intermediate line and the diodes. When power is supplied to the load by the discharge of the electricity storage group, the voltage value of the electricity storage group including the activated current breaker becomes 0 [V], and only the electromotive voltage of the electricity storage group is applied across both ends of the activated current breaker.

For example, it is assumed that the electricity storage device has two electricity storage groups, and the negative electrode terminal of one electricity storage group is connected to the positive electrode terminal of the other electricity storage group. If the current breaker of the electricity storage element included in one electricity storage group is activated, one electricity storage group is not discharged, and only the other electricity storage group can be discharged. A discharge current of the other electricity storage group flows to a capacitor unit through the first intermediate line and the diodes connected in parallel to one electricity storage group. For this reason, when the power of the electricity storage group is supplied to the load, the voltage value of the capacitor unit becomes equal to the voltage value of the other electricity storage group.

In one electricity storage group, the potential (positive electrode potential) on the positive electrode terminal represents the voltage value of the capacitor unit, and the potential (negative electrode potential) on the negative electrode terminal represents the voltage value of the other electricity storage group. The voltage value of the capacitor unit becomes equal to the voltage value of the other electricity storage group. Accordingly, the voltage value (the difference between the positive electrode potential and the negative electrode potential) of one electricity storage group becomes 0 [V]. Therefore, only the electromotive voltage of one electricity storage group is applied across both ends of the activated current breaker.

The electromotive voltage of one electricity storage group becomes lower than the voltage value of the electricity storage device. For this reason, according to the above-described aspect, it is possible to decrease the voltage value to be applied across both ends of the activated current breaker compared to a case where the voltage value of the electricity storage device is applied across both ends of the activated current breaker as in Japanese Patent No. 05333671. Even when the electricity storage device has three or more electricity storage groups, only the electromotive voltage of the electricity storage group including the activated current breaker is applied across both ends of the activated current breaker.

In the above-described aspect, the electricity storage system may further include at least two capacitors and a second intermediate line. At least two capacitors may be connected to the positive electrode line and the negative electrode line, and may be connected in parallel to the diodes. The second intermediate line may be connected between the second connection point and a third connection point. At the third connection point, the capacitors are connected together.

Each diode is connected in parallel to each electricity storage group through the first intermediate line. Accordingly, each capacitor is connected in parallel to each electricity storage group through the second intermediate line and the first intermediate line. In a configuration in which the second intermediate line is not provided, if the current breaker is activated at the time of charging of the electricity storage device, a charge current flows only to the capacitor unit, and the voltage value of the capacitor unit easily increases. Here, if the second intermediate line is provided, the charge current can also be made to flow to the electricity storage group not including the activated current breaker. In this way, the charge current is distributed to the electricity storage group and the capacitor connected in parallel, whereby it is possible to suppress an increase in the voltage value of the capacitor. As a result, it is possible to suppress an increase in the voltage value of the capacitor unit having a plurality of capacitors.

The electricity storage system may further include a fuse. The fuse is provided in the first intermediate line, and is melted by the discharge current of the electricity storage group according to short-circuiting of the diodes.

Each electricity storage group is connected in parallel to each diode through the first intermediate line. Accordingly, when short-circuiting of the diodes occurs, the discharge current of the electricity storage group flows through the diodes, and the electricity storage group is continuously discharged. If the fuse provided in the first intermediate line is melted by a current generated at the time of short-circuiting of the diodes, it is possible to prevent the electricity storage group from being continuously discharged.

The electricity storage system may further include a first relay, a second relay, and a third relay. The first relay may be provided between the first connection point and the second connection point in the positive electrode line. The second relay may be provided between the first connection point and the second connection point in the negative electrode line. The third relay may be provided in the first intermediate line.

The relays are provided as described above, whereby it is possible to break the current path in which the electricity storage group and the diode are connected in parallel. When a failure (short-circuiting or leakage) in the diode occurs, if the electricity storage group and the diode are kept connected in parallel, the discharge current of the electricity storage group flows from the cathode toward the anode in the diode, and the electricity storage group is continuously discharged. Here, if the relay provided on the current path in which the discharge current of the electricity storage group flows is switched off, it is possible to prevent the electricity storage group from being continuously discharged.

In the above-described aspect, the electricity storage system may further include a voltage sensor, a relay, and a controller. The voltage sensor may be configured to detect a voltage value of the capacitor. The relay may be configured to make a discharge current of each electricity storage group flow to each of the diodes through the first intermediate line. The controller may be configured to determine that the diodes have a failure when the voltage value at a time which the relay is driven such that the discharge current flows to each of the diodes is substantially 0.

With this, it is possible to determine the occurrence of failures (disconnection) in the diodes.

In the above-described aspect, the electricity storage system may further include a voltage sensor, a relay, and a controller. The voltage sensor may be configured to detect a voltage value of the capacitor. The relay may be configured to control a current flowing to each of the diodes through the first intermediate line. The controller may be configured to calculate a decrease amount of the voltage value according to a start of current application to the load with a predetermined current value when the relay is driven such that a discharge current of each electricity storage group flows to each of the diodes. The controller may be configured to determine that the diodes have a failure when the decrease amount is equal to or greater than a predetermined amount.

When the load is switched from a non-current application state to a current application state, a voltage drop is generated by a resistance value of a diode disposed on the current path in which a discharge current of an electricity storage group flows. When the current value at the time of current application to the load is a predetermined current value (fixed value), the decrease amount of the voltage value at this time depends on the resistance value of the diode. Accordingly, it is possible to understand the resistance value of the diode based on the decrease amount of the voltage value. The more the resistance value of the diode increases, the more the decrease amount of the voltage value increases. Accordingly, when the decrease amount of the voltage value is equal to or greater than a predetermined amount, it is possible to determine that the resistance value of the diode increases and a failure occurs.

In the above-described aspect, the electricity storage system may further include a voltage sensor, a current sensor, a relay, and a controller. The voltage sensor may be configured to detect a voltage value of the capacitor. The current sensor may be configured to detect a current value on the first intermediate line. The relay may be configured to control a current flowing to each of the diodes through the first intermediate line. The controller may be configured to calculate a resistance value of each diode based on a decrease amount of the voltage value at the time of a start of current application to the load and the current value at the time of current application to the load when the relay is driven such that a discharge current of each electricity storage group flows to each of the diodes. The controller may be configured to determine that the diodes have a failure when the resistance value is equal to or greater than a predetermined value.

The decrease amount of the voltage value of the capacitor unit depends on the resistance value of the diode and the current value at the time of current application to the load. Accordingly, the resistance value of the diode may be calculated based on the decrease amount of the voltage value and the current value at the time of current application to the load. In this case, it is possible to determine that the resistance value of the diode increases and a failure occurs when the resistance value of the diode is equal to or greater than a predetermined value.

In the above-described aspect, the electricity storage system may further include a first voltage sensor, a second voltage sensor, a current sensor, and a relay. The first voltage sensor may be configured to detect a voltage value of each electricity storage group. The second voltage sensor may be configured to detect a voltage value of the capacitor. The current sensor may be configured to detect a current value on the first intermediate line. The relay may be configured to control a current flowing to each of the diodes through the first intermediate line. The controller may be configured to calculate a resistance value of each diode based on the voltage value of the capacitor at the time of discharging of the capacitor, a voltage value of a predetermined electricity storage group, and the current value at the time of discharging of the capacitor when the relay is driven such that a discharge current of each electricity storage group flows to each of the diodes. The predetermined electricity storage group is an electricity storage group to be discharged by the driving of the relay. The controller may be configured to determine that the diodes have a failure when the resistance value is equal to or greater than a predetermined value.

When the relay is driven such that the discharge current of each electricity storage group flows to each of the diodes, the resistance value of each of the diodes can be calculated based on the voltage value of the capacitor unit at the time of discharging of the capacitor unit, a voltage value of an electricity storage group to be discharged by the driving of the relay, and the current value at the time of discharging of the capacitor unit. Then, when the calculated resistance value is equal to or greater than a predetermined value, it is possible to determine that the resistance value of the diode increases and the diode has a failure.

In the above-described aspect, the electricity storage system may further include a temperature sensor, a relay, and a controller. The temperature sensor may be configured to detect a temperature of each diode. The relay may be configured to control a current flowing to each of the diodes through the first intermediate line. The controller may be configured to determine that the diodes have a failure when the relay is driven such that a discharge current of each electricity storage group flows to each of the diodes and the temperature of a predetermined diode is equal to or higher than a predetermined temperature. The predetermined diode is a diode which is connected in parallel to an electricity storage group to be discharged by the driving of the relay.

As described above, each electricity storage group is connected in parallel to each diode, and when the electricity storage group is discharged, the discharge current does not flow to the diode connected in parallel to the electricity storage group. Here, when the diode has a failure, a leakage current may flow to the diode. At this time, the diode generates heat. Accordingly, when the temperature of the diode connected in parallel to the electricity storage group to be discharged by the driving of the relay is equal to or higher than a predetermined temperature, it is possible to determine that a failure (leakage) in the diode occurs.

In the above-described aspect, the electricity storage system may further include a current sensor, a relay, and a controller. The current sensor may be configured to detect a current value on the first intermediate line. The relay may be configured to control a current flowing to each of the diodes through the first intermediate line. The controller may be configured to determine that a predetermined diode has a failure when the relay is driven such that a discharge current of each electricity storage group flows to each of the diodes and when the current value at the time of no current application to the load is equal to or greater than a predetermined value. The predetermined diode is a diode which is connected in parallel to the electricity storage group to be discharged by the driving of the relay.

When the relay is driven such that the discharge current of each electricity storage group flows to each of the diodes through the first intermediate line, if current application to the load is not performed, no current flows on the first intermediate line. Here, the diode connected in parallel to the electricity storage group to be discharged has a failure, and if a leakage current flows to the diode, a current flows on the first intermediate line. Accordingly, when current application to the load is not performed, it is possible to determine that a failure (leakage) in the diode occurs when the current value on the first intermediate line is equal to or greater than a predetermined value.

In the above-described aspect, the diodes may be Zener diodes.

When charging the electricity storage device, if the current breaker is activated, the capacitor unit is charged. Here, the Zener diode is connected in parallel to the capacitor unit. Accordingly, the voltage value of the capacitor unit is not greater than the breakdown voltage value of the Zener diode. With this, it is possible to suppress an excessive increase in the voltage value of the capacitor unit. For example, the more the voltage value of the capacitor unit increases, the more the voltage value to be applied to the activated current breaker may increase. In this case, an increase in the voltage value of the capacitor unit is suppressed, thereby suppressing an increase in the voltage value to be applied to the activated current breaker.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram showing the configuration of a battery system according to Example 1;

FIG. 2 is a schematic view showing the configuration of a single battery;

FIG. 3 is a flowchart showing processing for controlling a voltage value of a capacitor in Example 1;

FIG. 4 is a diagram showing a configuration in which an assembled battery is divided into three or more battery groups in a modification example of Example 1;

FIG. 5 is a diagram showing a configuration for determining a failure in a diode in Example 2;

FIG. 6 is a flowchart showing processing for determining a failure (disconnection) in a diode in Example 2;

FIG. 7 is a flowchart showing processing for determining a failure (short-circuiting) in a diode in Example 2;

FIG. 8 is a flowchart showing processing for determining a failure (increase in resistance value) in a diode in Example 2;

FIG. 9 is a flowchart showing processing for determining a failure (increase in resistance value) in a diode in Example 2;

FIG. 10 is a flowchart showing processing for determining a failure (increase in resistance value) in a diode in Example 2;

FIG. 11 is a flowchart showing processing for determining a failure (leakage) in a diode in Example 2;

FIG. 12 is a flowchart showing processing for determining a failure (leakage) in a diode in Example 2;

FIG. 13 is a flowchart showing processing for determining a failure in a system main relay or a diode in Example 3;

FIG. 14 is a diagram showing the configuration of a battery system according to Example 4;

FIG. 15 is a diagram showing a configuration in which an assembled battery is divided into three or more battery groups in a modification example of Example 4;

FIG. 16 is a diagram showing the configuration of a battery system according to Example 5;

FIG. 17 is a diagram showing a configuration in which an assembled battery is divided into three or more battery groups in a modification example of Example 5;

FIG. 18 is a diagram showing the configuration of a battery system according to a modification example of Example 5;

FIG. 19 is a diagram showing the configuration of a battery system according to Example 6;

FIG. 20 is a diagram showing a configuration in which an assembled battery is divided into three or more battery groups in a modification example of Example 6; and

FIG. 21 is a diagram showing the configuration of a battery system according to a modification example of Example 6.

### DETAILED DESCRIPTION OF EMBODIMENTS

Hereinafter, embodiments will be described.

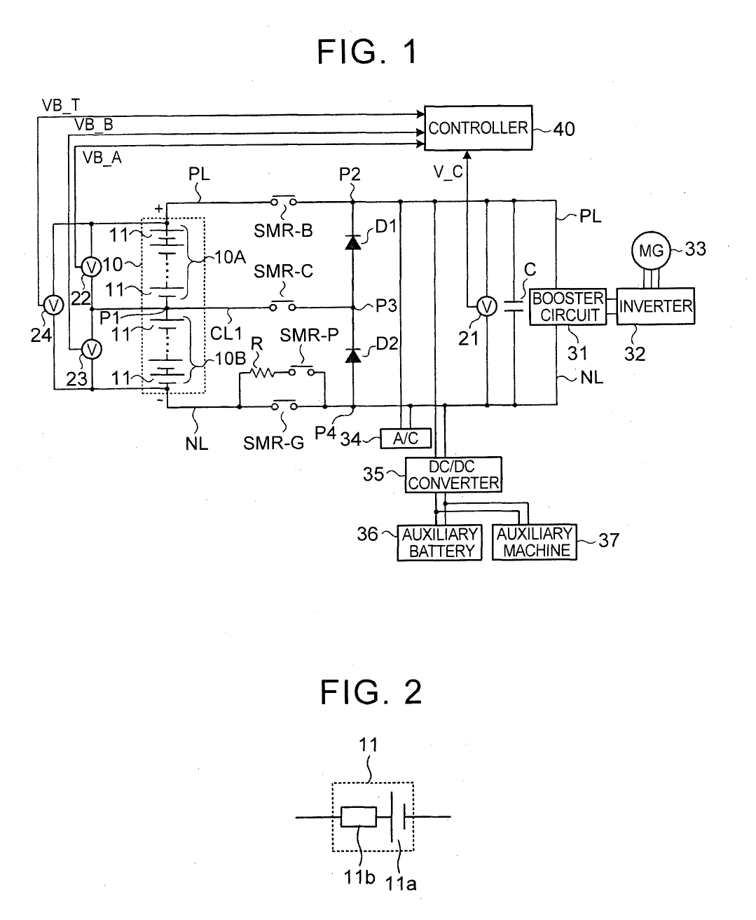

A battery system (corresponding to an electricity storage system of some embodiments) according to Example 1 will be described. FIG. 1 is a schematic view showing the configuration of the battery system. The battery system shown in FIG. 1 is mounted in a vehicle.

An assembled battery (corresponding to an electricity storage device of some embodiments) 10 has a plurality of single batteries (corresponding to electricity storage elements of some embodiments) 11 connected in series. As the single batteries 11, secondary batteries are used. Instead of secondary batteries, electric double layer capacitors (corresponding to electricity storage elements of some embodiments) can be used. The assembled battery 10 is divided into two battery groups (corresponding to electricity storage groups of some embodiments) 10A, 10B, and the battery groups 10A, 10B are connected in series. Each of the battery groups 10A, 10B has a plurality of single batteries 11 connected in series.

A positive electrode line PL is connected to a positive electrode terminal of the assembled battery 10 (battery group 10A), and a negative electrode line NL is connected to a negative electrode terminal of the assembled battery 10 (battery group 10B). To a connection point P1 of the battery group 10A and the battery group 10B, one end of an intermediate line (corresponding to a first intermediate line of some embodiments) CL1 is connected. A system main relay SMR-C is provided in the intermediate line CL1. The system main relay SMR-C is switched between on and off in response to a control signal from the controller 40. In this way, a current flowing to the intermediate line CL1 is controlled by the system main relay SMR-C.

A system main relay SMR-B is provided in the positive electrode line PL. The system main relay SMR-B is switched between on and off in response to a control signal from the controller 40. In this way, a current flowing to the positive electrode line PL is controlled by the system main relay SMR-B. A system main relay SMR-G is provided in the negative electrode line NL. The system main relay SMR-G is switched between on and off in response to a control signal from the controller 40. In this way, a current flowing to the negative electrode line NL is controlled by the system main relay SMR-G.

A resistor element R and a system main relay SMR-P are connected in parallel to the system main relay SMR-G. The resistor element R and the system main relay SMR-P are connected in series. The system main relay SMR-P is switched between on and off in response to a control signal from the controller 40. The resistor element R and the system main relay SMR-P may be connected in parallel to the system main relay SMR-B, not the system main relay SMR-G.

A capacitor (corresponding to a capacitor unit of some embodiments) C is connected to the positive electrode line PL and the negative electrode line NL. The capacitor C is used to smooth a voltage value between the positive electrode line PL and the negative electrode line NL. Here, the resistor element R is used to suppress the flow of a rush current in the capacitor C. A voltage sensor 21 detects a voltage value V_C of the capacitor C and outputs the detection result to the controller 40.

A voltage sensor 22 detects a voltage value VB_A of the battery group 10A and outputs the detection result to the controller 40. A voltage sensor 23 detects a voltage value VB_B of the battery group 10B and outputs the detection result to the controller 40. A voltage sensor 24 detects a voltage value VB_T of the assembled battery 10 and outputs the detection result to the controller 40. The voltage values VB_A, VB_B, VB_T are used, for example, when controlling the charging or discharging of the assembled battery 10.

Diodes D1, D2 are connected in series between the positive electrode line PL and the negative electrode line NL. Specifically, a cathode of the diode D1 is connected to the positive electrode line PL positioned between the system main relay SMR-B and a booster circuit 31. In other words, the system main relay SMR-B is provided between the positive electrode terminal of the assembled battery 10 and a connection point P2 of the cathode of the diode D1 and the positive electrode line PL on the positive electrode line PL.

An anode of the diode D1 is connected to a cathode of the diode D2. The other end of the intermediate line CL1 is connected to a connection point P3 of the diodes D1, D2. An anode of the diode D2 is connected to the negative electrode line NL positioned between the system main relay SMR-G and the booster circuit 31. In other words, the system main relay SMR-G is provided between the negative electrode terminal of the assembled battery 10 and a connection point P4 of the anode of the diode D2 and the negative electrode line NL on the negative electrode line NL.

With this, the diode D1 is connected in parallel to the battery group 10A through the positive electrode line PL and the intermediate line CL1. Here, the cathode of the diode D1 is connected to a positive electrode terminal of the battery group 10A, and the anode of the diode D1 is connected to a negative electrode terminal of the battery group 10A. The diode D2 is connected in parallel to the battery group 10B through the intermediate line CL1 and the negative electrode line NL. Here, the cathode of the diode D2 is connected to a positive electrode terminal of the battery group 10B, and the anode of the diode D2 is connected to the negative electrode terminal of the battery group 10B.

The assembled battery 10 is connected to the booster circuit 31 through the positive electrode line PL and the negative electrode line NL. The booster circuit 31 boosts an output voltage of the assembled battery 10 and outputs power after boosting to an inverter 32. The inverter 32 converts DC power output from the booster circuit 31 to AC power and outputs AC power to a motor generator (MG) 33. The motor generator 33 receives AC power output from the inverter 32 and generates kinetic energy for traveling of the vehicle.

The motor generator 33 converts kinetic energy generated at the time of braking of the vehicle to electric energy (AC power) and outputs AC power to the inverter 32. The inverter 32 converts AC power output from the motor generator 33 to DC power and outputs DC power to the booster circuit 31. The booster circuit 31 deboosts an output voltage of the inverter 32 and outputs power after deboosting to the assembled battery 10. With this, the assembled battery 10 can be charged. In this example, although the booster circuit 31 is used, the booster circuit 31 may be omitted.

An air conditioner (A/C) 34 is connected to the positive electrode line PL and the negative electrode line NL. The air conditioner 34 is operated with discharge power of the assembled battery 10 (battery groups 10A, 10B). A DC/DC converter 35 is connected to the positive electrode line PL and the negative electrode line NL. The DC/DC converter 35 deboosts an output voltage of the assembled battery 10 (battery groups 10A, 10B) and supplies power after deboosting to an auxiliary battery 36 or an auxiliary machine 37.

Processing (an example) when the battery system shown in FIG. 1 is actuated (Ready-On) will be described. First, the controller 40 switches the system main relays SMR-B, SMR-P from off to on. With this, a discharge current of the assembled battery 10 flows to the capacitor C through the resistor element R, whereby the capacitor C is charged. Next, the controller 40 switches the system main relay SMR-G from off to on and switches the system main relay SMR-P from on to off.

With this, the battery system is activated. Here, the controller 40 switches the system main relay SMR-C from off to on before activating the battery system. The timing of switching the system main relay SMR-C from off to on can be appropriately determined. When the battery system is activated, the system main relays SMR-C, SMR-B, SMR-G are on. The controller 40 switches the system main relays SMR-C, SMR-B, SMR-G from on to off, whereby the battery system can be stopped (Ready-Off).

When the battery system is activated, first, only one of the battery groups 10A, 10B may be connected to the capacitor C to charge the capacitor C. Thereafter, if the other battery group is discharged, the battery system can be actuated.

In the configuration shown in FIG. 1, the system main relays SMR-P, SMR-C are switched on, whereby only the battery group 10B is discharged to charge the capacitor C. Thereafter, the battery group 10A is discharged, whereby the battery system can be actuated. In the configuration shown in FIG. 1, when only the battery group 10A is discharged to charge the capacitor C, a rush current may flow to the capacitor C. For this reason, in some embodiments the resistor element R and the system main relay SMR-P are connected in parallel to at least one of the system main relays SMR-B, SMR-C.

If a bidirectional DC/DC converter 35 is used as the DC/DC converter 35, the capacitor C may be charged with discharge power of the auxiliary battery 36. Specifically, the DC/DC converter 35 can boost an output voltage of the auxiliary battery 36 and can output power after boosting to the capacitor C. Before the system main relays SMR-B, SMR-G are switched on, as described above, if the capacitor C is charged, the resistor element R may not be provided. That is, the resistor element R and the system main relay SMR-P can be omitted.

As shown in FIG. 2, a single battery 11 has a power generation element 11a and a current breaker 11b. The power generation element 11a is an element which performs charging and discharging, and as well known in the art, can have a positive electrode plate, a negative electrode plate, and a separator. The current breaker 11b is used to break a current path inside the single battery 11. When the current breaker 11b is activated, the power generation element 11a is not charged or discharged.

For example, when gas is generated inside the single battery 11 and the internal pressure of the single battery 11 increases, the current breaker 11b can be activated. As the current breaker 11b, a valve which is deformed when the internal pressure of the single battery 11 increases can be used. The valve is deformed, thereby mechanically breaking the current path of the power generation element 11a. The configuration of this current breaker 11b is well known in the art, and thus, detailed description will be omitted. When an excessive current flows to the power generation element 11a, the current breaker 11b can be activated. As the current breaker 11b, for example, a fuse can be used.

When the current breaker 11b is activated, a high voltage is applied across both terminals of the current breaker 11b. In this example, as described below, it is possible to decrease a voltage value to be applied to the activated current breaker 11b.

Hereinafter, a case where the current breaker 11b of the single battery 11 (arbitrary one) included in the battery group 10A is activated will be described. Here, a behavior when the current breaker 11b of the single battery 11 (arbitrary one) included in the battery group 10B is activated is the same as a behavior when the current breaker 11b of the single battery 11 included in the battery group 10A is activated, and thus, detailed description will be omitted.

First, a case where the current breaker 11b is activated when the battery system shown in FIG. 1 is actuated will be described.

Before the battery system is actuated, the capacitor C is discharged, and the voltage value V_C of the capacitor C is 0 [V]. When the battery system is actuated, as described above, the system main relays SMR-B, SMR-P are switched from off to on. The current breaker 11b of the single battery 11 included in the battery group 10A is activated. Accordingly, the battery group 10A is not discharged.

Here, since the system main relay SMR-C is on, a discharge current of the battery group 10B flows through the intermediate line CL1, the diode D1, the positive electrode line PL, the capacitor C, and the negative electrode line NL in this order, whereby the capacitor C is charged. With this, the voltage value V_C of the capacitor C becomes equal to the voltage value VB_B of the battery group 10B. Here, the potential (positive electrode potential) on the positive electrode terminal of the battery group 10A represents the voltage value V_C, and the potential (negative electrode potential) on the negative electrode terminal of the battery group 10A represents the voltage value VB_B. Accordingly, the voltage value (the difference between the positive electrode potential and the negative electrode potential) VB_A of the battery group 10A becomes 0 [V]. With this, the electromotive voltage of the battery group 10A is applied to the activated current breaker 11b.

If the intermediate line CL1 is omitted, when the current breaker 11b is activated, the positive electrode terminal and the negative electrode terminal of the assembled battery 10 are at the same potential, and the voltage value VB_T of the assembled battery 10 becomes 0 [V]. At this time, the electromotive voltage of the assembled battery 10 is applied to the activated current breaker 11b. The number of single batteries 11 of the battery group 10A is less than the number of single batteries 11 of the assembled battery 10. Accordingly, the electromotive voltage of the battery group 10A is lower than the electromotive voltage of the assembled battery 10. For this reason, according to this example, it is possible to decrease the voltage value to be applied to the activated current breaker 11b compared to a configuration in which the intermediate line CL1 is omitted.

Next, a case where the current breaker 11b is activated when power is supplied to a load (hereinafter, simply referred to a load), such as the motor generator 33, the air conditioner 34, or the auxiliary machine 37, will be described. If the current breaker 11b is activated, similarly to the above-described case, the battery group 10A is not discharged, and only the battery group 10B is discharged. Before the current breaker 11b is activated, the voltage value V_C of the capacitor C is equal to the voltage value VB_T of the assembled battery 10. After the current breaker 11b is activated, the capacitor C is discharged and the voltage value V_C decreases by the operation of the load. Since the battery group 10B is discharged, the voltage value V_C of the capacitor C becomes equal to the voltage value VB_B of the battery group 10B.

With this, the positive electrode terminal and the negative electrode terminal of the battery group 10A are at the same potential, and the voltage value VB_A of the battery group 10A becomes 0 [V]. Accordingly, the electromotive voltage of the battery group 10A is applied to the activated current breaker 11b. It is possible to decrease the voltage value to be applied to the activated current breaker 11b compared to a configuration in which the intermediate line CL1 is omitted.

Next, a case where the current breaker 11b is activated when the assembled battery 10 is charged will be described. If the current breaker 11b is activated, a charge current from the booster circuit 31 cannot be made to flow to the assembled battery 10. Furthermore, since the cathode of the diode D1 is connected to the positive electrode line PL, it is not possible to charge the battery group 10B through the intermediate line CL1.

At this time, a charge current from the booster circuit 31 flows to the capacitor C, whereby the voltage value V_C of the capacitor C increases. Here, the potential on the negative electrode terminal of the battery group 10A becomes the voltage value VB_B of the battery group 10B, and the potential on the positive electrode terminal of the battery group 10A becomes the voltage value V_C. Considering the electromotive voltage of the battery group 10A, a voltage value corresponding to the difference between the total sum (that is, the voltage value VB_T) of the voltage values VB_B, VB_A and the voltage value V_C is applied to the activated current breaker 11b.

Since the battery groups 10A, 10B are not charged, the voltage values VB_A, VB_B are not changed. For this reason, the more the voltage value V_C of the capacitor C increases, the more the voltage value to be applied to the activated current breaker 11b increases. Accordingly, in this example, the voltage value V_C of the capacitor C is equal to or less than an upper limit voltage value V_ov1 determined in advance. With this, the voltage value V_C is not greater than the upper limit voltage value V_ov1. At this time, the voltage value (maximum value) to be applied to the activated current breaker 11b becomes the difference between the upper limit voltage value V_ov1 and the total sum (that is, the voltage value VB_T) of the voltage values VB_A, VB_B.

If the upper limit voltage value V_ov1 is appropriately set, the voltage value to be applied to the activated current breaker 11b can be made less than the voltage value VB_T of the assembled battery 10. That is, if the voltage value corresponding to the difference between the upper limit voltage value V_ov1 and the total sum (voltage value VB_T) of the voltage values VB_A, VB_B is less than the voltage value VB_T, as described above, it is possible to decrease the voltage value to be applied to the activated current breaker 11b.

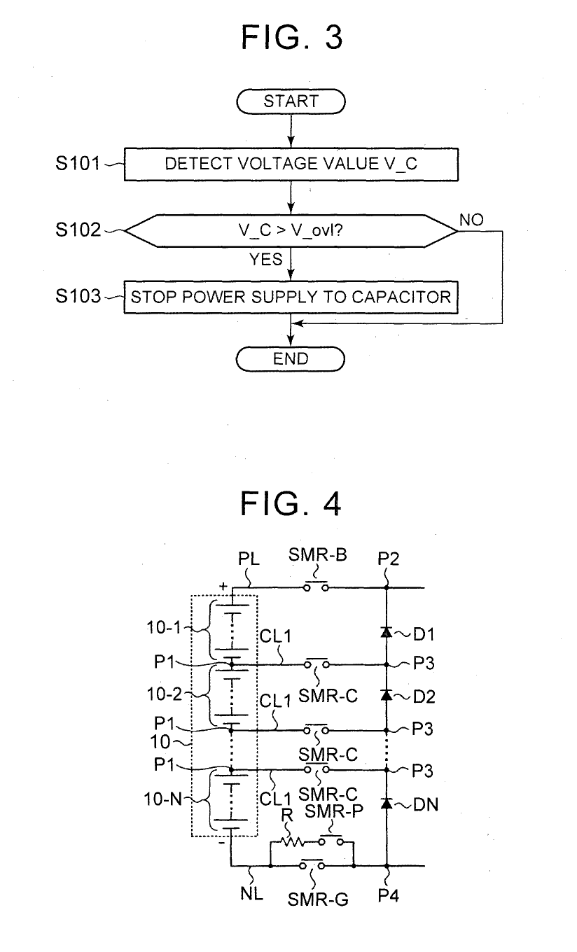

Here, processing for making the voltage value V_C be equal to or less than the upper limit voltage value V_ov1 will be described referring to the flowchart of FIG. 3. The processing shown in FIG. 3 is executed by the controller 40.

In Step S101, the controller 40 detects the voltage value V_C of the capacitor C using the voltage sensor 21. In Step S102, the controller 40 determines whether or not the voltage value V_C detected in Step S101 is greater than the upper limit voltage value V_ov1. When the voltage value V_C is equal to or less than the upper limit voltage value V_ov1, the controller 40 ends the processing shown in FIG. 3.

When the voltage value V_C is greater than upper limit voltage value V_ov1, in Step S103, the controller 40 stops power supply to the capacitor C. For example, the controller 40 stops power generation by the motor generator 33. With this, it is possible to prevent a charge current from flowing to the capacitor C.

If the upper limit voltage value V_ov1 is lower, even when the current breaker 11b is not activated, and the charging or discharging of the assembled battery 10 is performed, Step S103 may be performed. In this case, even if the assembled battery 10 can be charged, the assembled battery 10 will not be able to be charged. Considering this point, the upper limit voltage value V_ov1 can be set.

In this example, although the diodes D1, D2 are used, Zener diodes D1, D2 can be used instead of the diodes D1, D2. Here, the Zener diodes D1, D2 can be connected in the same manner as the diodes D1, D2. If the voltage value to be applied to the Zener diodes D1, D2 is greater than the breakdown voltage value of the Zener diodes D1, D2, a current flows from the cathode to the anode in the Zener diodes D1, D2.

For example, when the current breaker 11b of the single battery 11 included in the battery group 10A is activated, the charge current can be made to flow to the battery group 10B through the Zener diode D1 and the intermediate line CL1. The voltage value V_C at this time becomes equal to the breakdown voltage value of the Zener diode D1. In this case, the voltage value V_C of the capacitor C connected in parallel to the Zener diodes D1, D2 is not greater than the breakdown voltage value of the Zener diodes D1, D2.

The Zener diodes D1, D2 are used, whereby the upper limit voltage value of the voltage value V_C of the capacitor C can be set to the breakdown voltage value of the Zener diodes D1, D2. Therefore, as in Step S103 of FIG. 3, even if the power supply to the capacitor C is not stopped, it is possible to prevent the voltage value V_C of the capacitor C from excessively increasing.

For example, when the current breaker 11b of the single battery 11 included in the battery group 10A is activated, the voltage value to be applied to the activated current breaker 11b is equal to or less than the difference between the total sum (that is, the voltage value VB_T) of the voltage values VB_A, VB_B and the breakdown voltage value of the Zener diodes D1, D2. The breakdown voltage value of the Zener diodes D1, D2 is appropriately set in the same manner as the above-described upper limit voltage value V_ov1, whereby it is possible to make the voltage value to be applied to the activated current breaker 11b be less than the voltage value VB_T of the assembled battery 10.

In this example, in the current path in which the battery group 10A and the diode D1 are connected in parallel, the system main relays SMR-B, SMR-C are provided. With this, at least one of the system main relays SMR-B, SMR-C is switched off, whereby it is possible to break the current path in which the battery group 10A and the diode D1 are connected in parallel.

When the system main relays SMR-B, SMR-C are on, if a failure (short-circuiting or leakage) in the diode D1 occurs, the discharge current of the battery group 10A flows from the cathode to the anode in the diode D1, and the battery group 10A is continuously discharged. At this time, if at least one of the system main relays SMR-B, SMR-C is switched off, it is possible to stop the discharging of the battery group 10A. Similarly, when a failure (short-circuiting or leakage) in the diode D2 occurs, the system main relays SMR-G, SMR-P or the system main relay SMR-C is switched off, whereby it is possible to prevent the battery group 10B from being continuously discharged.

In this example, although the assembled battery 10 is divided into the two battery groups 10A, 10B, the assembled battery 10 may be divided into three or more battery groups. In a configuration shown in FIG. 4, the assembled battery 10 is divided into N battery groups 10-1 to 10-N. Here, similarly to this example, one end of an intermediate line CL1 is connected to a connection point P1 of two battery groups 10 (for example, battery groups 10-1, 10-2) connected in series. With this, “N−1” intermediate lines CL1 are provided. A system main relay SMR-C is provided in each of the intermediate lines CL1.

N diodes D1 to DN are connected in series between the positive electrode line PL and the negative electrode line NL. A cathode of the diode D1 is connected to the positive electrode line PL, and an anode of the diode D1 is connected to a cathode of the diode D2. A cathode of another diode is connected to an anode of the diode D2. A cathode of the diode DN is connected to an anode of another diode, and an anode of the diode DN is connected to the negative electrode line NL. Here, the other end of the intermediate line CL1 is connected to a connection point P3 of two diodes (for example, diodes D1, D2) connected in series.

The more the number of battery groups increases, the lower the voltage value of each battery group, and the less the voltage value to be applied to the activated current breaker 11b decreases. For example, when a current breaker 11b of a single battery 11 (arbitrary one) included in the battery group 10-2 is activated, the electromotive voltage of the battery group 10-2 is applied to the activated current breaker 11b.

In the assembled batteries 10 shown in FIGS. 1 and 4, when the number of single batteries 11 of the assembled battery 10 is the same, the number of single batteries 11 of the battery group 10-2 can be made smaller than the number of single batteries 11 of each of the battery groups 10A, 10B. In the assembled batteries 10 shown in FIGS. 1 and 4, when the same single battery 11 is used, the voltage value of the battery group 10-2 is less than the voltage values VB_A, VB_B of the respective battery groups 10A, 10B. Therefore, according to the configuration shown in FIG. 4, it is possible to decrease the voltage value to be applied to the activated current breaker 11b compared to the configuration shown in FIG. 1.

A battery system according to Example 2 will be described. In this example, the same components as the components described in Example 1 are represented by the same reference numerals, and detailed description will be omitted. In this example, failures in the diodes D1, D2 described in Example 1 are determined. Hereinafter, a difference from Example 1 will be described.

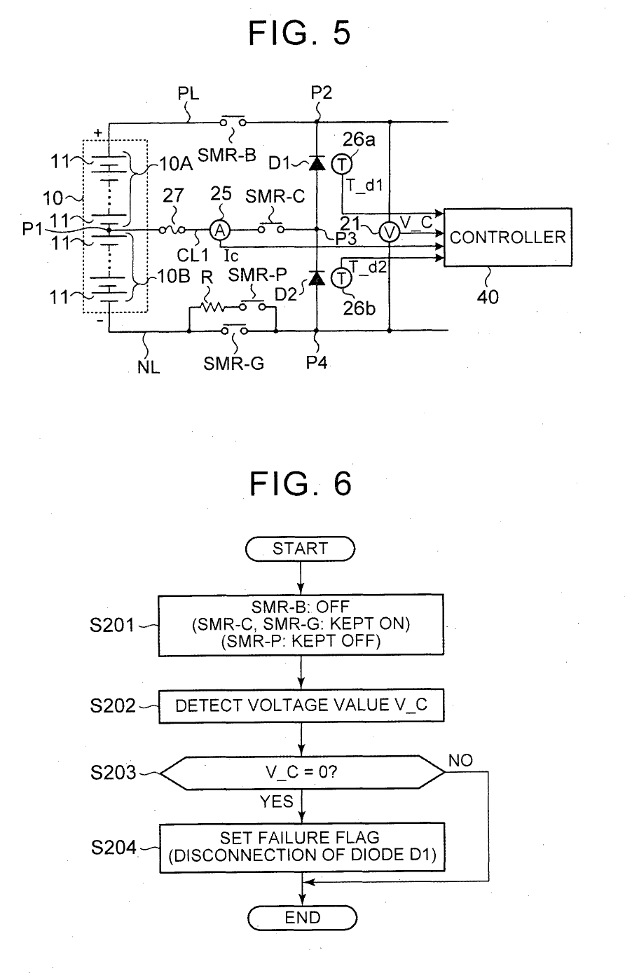

When determining failure in the diodes D1, D2, as shown in FIG. 5, the voltage sensor 21, a current sensor 25, temperature sensors 26a, 26b, and a fuse 27 can be used. The current sensor 25 is provided in the intermediate line CL1, and detects a current value Ic on the intermediate line CL1 and outputs the detection result to the controller 40.

The temperature sensor 26a detects the temperature T_d1 of the diode D1 and outputs the detection result to the controller 40. The temperature sensor 26b detects the temperature T_d2 of the diode D2 and outputs the detection result to the controller 40. The fuse 27 is provided in the intermediate line CL1 and is melted when the current value Ic is equal to or greater than a threshold value Ic_th.

There are four kinds of failures in the diodes D1, D2. Specifically, there are disconnection of the diodes D1, D2, short-circuiting of the diodes D1, D2, an increase in the resistance value of each of the diodes D1, D2, and leakage of the diodes D1, D2. Hereinafter, processing for determining these failures will be described.

First, processing for determining disconnection (disconnection possibility) of the diode D1 will be described referring to the flowchart of FIG. 6. The processing shown in FIG. 6 is executed by the controller 40. For example, when the battery system is switched from an actuation state to a stop state, the processing shown in FIG. 6 can be performed. Here, when starting the processing shown in FIG. 6, the system main relays SMR-B, SMR-C, SMR-G are on, and the system main relay SMR-P is off.

In Step S201, the controller 40 switches the system main relay SMR-B from on to off. The system main relays SMR-C, SMR-G are kept on, and the system main relay SMR-P is kept off. With this, only the battery group 10B can be discharged. Here, before the system main relay SMR-B is switched off, the voltage value V_C of the capacitor C becomes the voltage value VB_T of the assembled battery 10. If the system main relay SMR-B is switched off, the capacitor C is discharged by the operation of the load. Since only the battery group 10B can be discharged, the voltage value V_C of the capacitor C decreases to the voltage value VB_B of the battery group 10B.

In Step S202, the controller 40 detects the voltage value V_C of the capacitor C using the voltage sensor 21. In Step S203, the controller 40 determines whether or not the voltage value V_C detected in Step S202 is 0 [V]. Here, considering the detection error of the voltage sensor 21, it may be determined whether or not the voltage value V_C is substantially 0 [V]. Specifically, it is possible to determine whether or not the voltage value V_C falls within the range of the detection error of the voltage sensor 21 based on 0 [V].

When the voltage value V_C is 0 [V], in Step S204, the controller 40 determines that the diode D1 may be disconnected, and sets a failure flag. If the diode D1 is disconnected, the discharge current of the battery group 10B does not flow to the capacitor C. Furthermore, since the capacitor C is discharged by the operation of the load, the voltage value V_C becomes 0 [V]. Accordingly, when the voltage value V_C is 0 [V], it can be determined that the diode D1 may be disconnected.

When the diode D1 is not disconnected, as described above, the voltage value V_C of the capacitor C represents the voltage value VB_B of the battery group 10B. In controlling the charging and discharging of the assembled battery 10 (battery groups 10A, 10B), the voltage value VB_B does not become 0 [V]. Accordingly, in Step S203, the voltage value V_C is different from 0 [V], and the controller 40 determines that the diode D1 is not disconnected and ends the processing shown in FIG. 6.

In the processing shown in FIG. 6, although the processing for determining disconnection of the diode D1 has been described, processing for determining disconnection (disconnection possibility) of the diode D2 can be performed in the same manner. Specifically, in Step S201 of FIG. 6, the system main relay SMR-G may be switched off. Then, if the voltage value V_C becomes 0 [V], it can be determined that the diode D2 may be disconnected.

When the battery system is switched from the stop state to the actuation state, disconnection of the diode D1 may be determined. Since the battery system is actuated, when the controller 40 switches on the system main relays SMR-C, SMR-P, if the diode D1 is not disconnected, the discharge current of the battery group 10B flows to the capacitor C. With this, the voltage value V_C of the capacitor C becomes the voltage value VB_B of the battery group 10B. If the diode D1 is disconnected, the discharge current of the battery group 10B does not flow to the capacitor C. Accordingly, the voltage value V_C of the capacitor C is kept at 0 [V].

Therefore, if the voltage value V_C of the capacitor C is detected, it is possible to determine whether or not the diode D1 is disconnected based on the voltage value V_C. That is, if the voltage value V_C is kept at 0 [V], it can be determined that the diode D1 may be disconnected.

When the battery system is actuated, similarly to the determination of disconnection of the diode D1 described above, disconnection of the diode D2 can be determined. Here, in order to determine disconnection of the diode D2, it is necessary to connect the resistor element R and the system main relay SMR-P in parallel to at least one of the system main relays SMR-B, SMR-C. In this case, when the battery system is actuated, for example, the controller 40 switches on the system main relay SMR-C and the system main relay SMR-P connected in parallel to the system main relay SMR-B.

With this, if the diode D2 is not disconnected, the discharge current of the battery group 10A can be made to flow to the capacitor C. Here, the resistor element R and the system main relay SMR-P are connected in parallel to the system main relay SMR-B, whereby it is possible to suppress the flow of a rush current to the capacitor C. The voltage value V_C is detected, and if the voltage value V_C is 0 [V], it can be determined that the diode D2 may be disconnected.

In the above-described processing, although disconnection of the diodes D1, D2 is determined based on the voltage value V_C, embodiments are not limited thereto. Specifically, disconnection of the diodes D1, D2 may be determined based on the current value Ic detected by the current sensor 25. If one of the diodes D1, D2 is disconnected, as described above, one of the battery groups 10A, 10B is not discharged. Accordingly, no current flows to the intermediate line CL1.

Therefore, it is determined whether or not the current value Ic detected by the current sensor 25 is 0 [A], and when the current value Ic is 0 [A], it can be determined that the diodes D1, D2 are disconnected. In this determination, considering the detection error of the current sensor 25, it is possible to determine whether or not the current value Ic falls within the range of the detection error based on 0 [A]. Then, if the current value Ic falls within the range of the detection error, it can be determined that the diodes D1, D2 are disconnected.

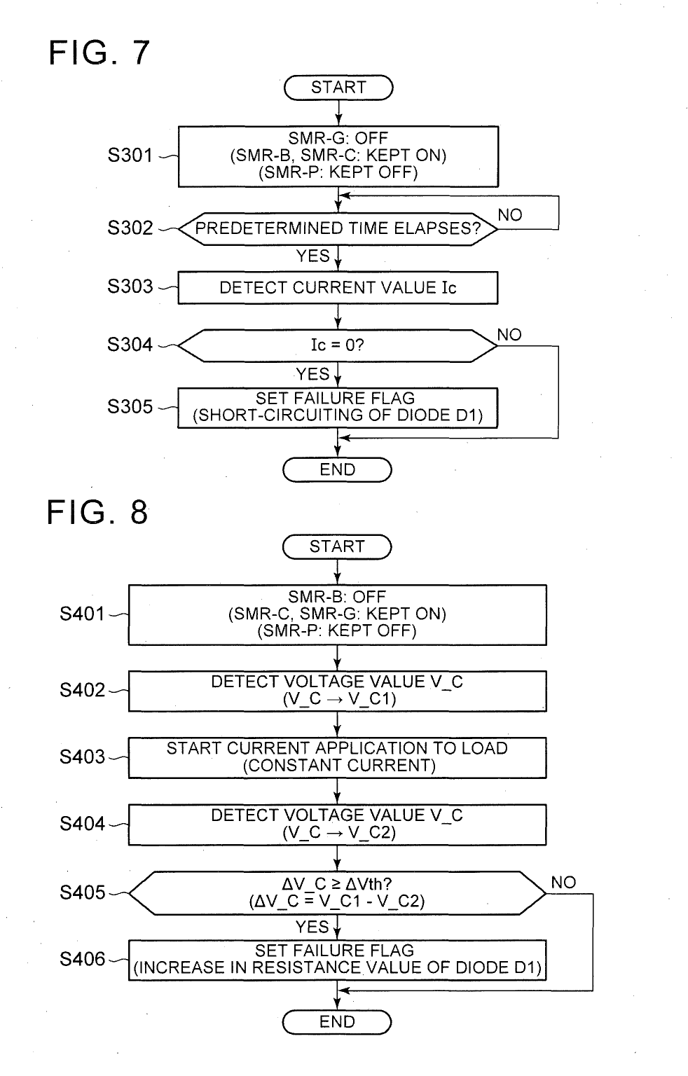

Next, processing for determining short-circuiting of the diode D1 will be described referring to the flowchart of FIG. 7. The processing shown in FIG. 7 is executed by the controller 40. When performing the processing shown in FIG. 7, the above-described fuse 27 is used. For example, when the battery system is switched from the actuation state to the stop state, the processing shown in FIG. 7 can be performed. Here, when starting the processing shown in FIG. 7, the system main relays SMR-B, SMR-C, SMR-G are on, and the system main relay SMR-P is off.

In Step S301, the controller 40 switches off the system main relay SMR-G. The system main relays SMR-B, SMR-C are kept on, and the system main relay SMR-P is kept off. With this, the battery group 10B cannot be discharged. In Step S302, the controller 40 waits until a predetermined time elapses after Step S301 ends. If the predetermined time has elapsed, in Step S303, the controller 40 detects the current value Ic using the current sensor 25.

In Step S304, the controller 40 determines whether or not the current value Ic detected in Step S303 is 0 [A]. Here, considering the detection error of the current sensor 25, it may be determined whether or not the current value Ic is substantially 0 [A]. Specifically, it is possible to determine whether or not the current value Ic falls within the range of the detection error of the current sensor 25 based on 0 [A].

When the current value Ic is 0 [A], in Step S305, the controller 40 determines that the diode D1 is short-circuited, and sets a failure flag. When the current value Ic is not 0 [A], the controller 40 determines that the diode D1 is not short-circuited and ends the processing shown in FIG. 7.

When the diode D1 is short-circuited, the discharge current of the battery group 10A flows to the diode D1. That is, in a current path including the positive electrode line PL, the diode D1, and the intermediate line CL1, the discharge current of the battery group 10A flows. The fuse 27 can be melted by the current at this time. In Step S302, the time until the fuse 27 is melted is secured.

If the fuse 27 is melted, the discharging of the battery group 10A is stopped, and no current flows to the intermediate line CL1. Accordingly, it is determined whether or not the current value Ic is 0 [A], thereby determining whether or not the diode D1 is short-circuited. Here, even when no power is supplied from the battery group 10A to the load, the current value Ic becomes 0 [A]. Accordingly, when power is supplied to the load, it is determined that the current value Ic is 0 [A], whereby it is possible to distinguish when the fuse 27 is melted and when no power is supplied to the load.

As described above, if the current value Ic is detected, it can be determined whether or not short-circuiting of the diode D1 occurs. Meanwhile, the fuse 27 is only provided in the intermediate line CL1, whereby it is possible to stop the discharging of the battery group 10A according to short-circuiting of the diode D1. That is, it is possible to prevent the battery group 10A from being continuously discharged.

Similarly to the above-described case, short-circuiting of the diode D2 may be determined. If the diode D2 is short-circuited, in a current path including the intermediate line CL1, the diode D2, and the negative electrode line NL, the discharge current of the battery group 10B flows. The fuse 27 can be melted by the current at this time. If the fuse 27 is melted, the discharging of the battery group 10B is stopped, and no current flows to the intermediate line CL1.

Therefore, similarly to the processing shown in FIG. 7, it is determined whether or not the current value Ic detected by the current sensor 25 is 0 [A], whereby it is possible to determine whether or not the diode D2 is short-circuited. Here, when determining short-circuiting of the diode D2, in Step S301 of FIG. 7, the system main relay SMR-B may be switched off.

Next, processing for determining an increase in the resistance value of the diode D1 will be described referring to the flowchart of FIG. 8. The processing shown in FIG. 8 is executed by the controller 40. For example, when the battery system is switched from the actuation state to the stop state, the processing shown in FIG. 8 can be performed. Here, when starting the processing shown in FIG. 8, the system main relays SMR-B, SMR-C, SMR-G are on, and the system main relay SMR-P is off.

In Step S401, the controller 40 switches off the system main relay SMR-B. The system main relays SMR-C, SMR-G are kept on, and the system main relay SMR-P is kept off. With this, only the battery group 10B can be discharged. In Step S402, the controller 40 detects the voltage value V_C (referred to as a voltage value V_C1) using the voltage sensor 21. Since only the battery group 10B can be discharged, the voltage value V_C represents the voltage value VB_B of the battery group 10B.

In Step S403, the controller 40 starts current application to the load. Here, a current value at the time of current application to the load is constant. The load is not limited to the above-described motor generator 33 or the like, and a discharge circuit only for discharging the capacitor C is also used. After the capacitor C is charged, an electric charge accumulated in the capacitor C should be released. For this reason, the discharge circuit may be connected to the capacitor C. Even when the discharge current of the capacitor C flows to the discharge circuit, the processing shown in FIG. 8 can be performed.

In Step S404, the controller 40 detects the voltage value V_C (referred to as a voltage value V_C2) using the voltage sensor 21. In Step S405, the controller 40 calculates a voltage difference (corresponding to a decrease amount of some embodiments) ΔV_C based on the voltage values V_C1, V_C2 detected in Steps S402 and S404. Specifically, the controller 40 calculates the voltage difference ΔV_C by subtracting the voltage value V_C2 from the voltage value V_C1. Then, in Step S405, the controller 40 determines whether or not the calculated voltage difference ΔV_C is equal to or greater than a predetermined difference (corresponding to a predetermined amount of some embodiments) ΔVth.

When the voltage difference ΔV_C is equal to or greater than the predetermined difference ΔVth, in Step S406, the controller 40 determines that the resistance value of the diode D1 increases, and sets a failure flag. If current application to the load starts in Step S403, a voltage drop according to the resistance value of the diode D1 occurs. That is, the voltage difference ΔV_C becomes a value obtained by multiplying the resistance value of the diode D1 by the current value.

As described above, when the current value at the time of current application to the load is constant, the voltage difference ΔV_C depends on the resistance value of the diode D1. That is, the more the resistance value of the diode D1 increases, the more the voltage difference ΔV_C increases. Accordingly, in the processing shown in FIG. 8, when the voltage difference ΔV_C is equal to or greater than the predetermined difference ΔVth, it is determined that the resistance value of the diode D1 increases. If a resistance value (predetermined value) Rth of the diode D1 when it is determined that the diode D1 has a failure is determined in advance, it is possible to specify the predetermined difference ΔVth based on the resistance value Rth. That is, the predetermined difference ΔVth becomes a value obtained by multiplying the resistance value Rth and the current value (fixed value) of the load.

In the processing shown in FIG. 8, although an increase in the resistance value of the diode D1 is determined, the same processing as the processing shown in FIG. 8 is performed, whereby it is possible to determine an increase in the resistance value of the diode D2. Specifically, in Step S401 of FIG. 8, the controller 40 may switch off the system main relay SMR-G.

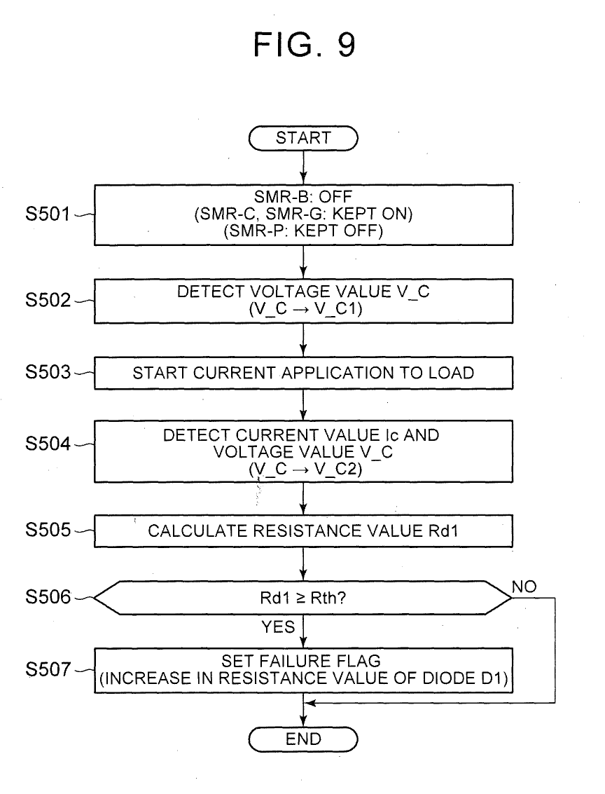

In the processing shown in FIG. 8, although the current value of the load is constant, when the current value of the load is changed, it is possible to determine an increase in the resistance value of the diode D1 based on processing shown in FIG. 9. The processing shown in FIG. 9 is executed by the controller 40. For example, when the battery system is switched from the actuation state to the stop state, the processing shown in FIG. 9 can be performed. Here, when starting the processing shown in FIG. 9, the system main relays SMR-B, SMR-C, SMR-G are on, and the system main relay SMR-P is off.

Steps S501 and S502 are the same as Steps S401 and S402 of FIG. 8. In Step S503, the controller 40 starts current application to the load. Here, the current value of the load is not constant. In Step S504, the controller 40 detects the current value Ic using the current sensor 25 and detects the voltage value V_C (voltage value V_C2) using the voltage sensor 21.

In Step S505, the controller 40 calculates a resistance value Rd1 of the diode D1 based on the detection results (voltage values V_C1, V_C2 and current value Ic) of Steps S502 and S504. Specifically, the controller 40 can calculate the resistance value Rd1 based on Expression (1).

$$Rd 1 = \frac{( V\_C1 - V\_C2 )}{Ic} \qquad ( 1 )$$

In Step S506, the controller 40 determines whether or not the resistance value Rd1 calculated in Step S505 is equal to or greater than a predetermined value Rth. The predetermined value Rth is a threshold value for determining whether or not the resistance value of the diode D1 increases, and can be set in advance. When the resistance value Rd1 is equal to or greater than the predetermined value Rth, in Step S507, the controller 40 determines that the resistance value of the diode D1 increases, and sets a failure flag. When the resistance value Rd1 is less than the predetermined value Rth, the controller 40 determines that the resistance value of the diode D1 does not increase and ends the processing shown in FIG. 9.

Here, even when the current value of the load is constant, the processing shown in FIG. 9 can be performed. Even when determining an increase in the resistance value of the diode D2, the same processing as the processing shown in FIG. 9 can be performed. In this case, in Step S501 of FIG. 9, the controller 40 may switch off the system main relay SMR-G.

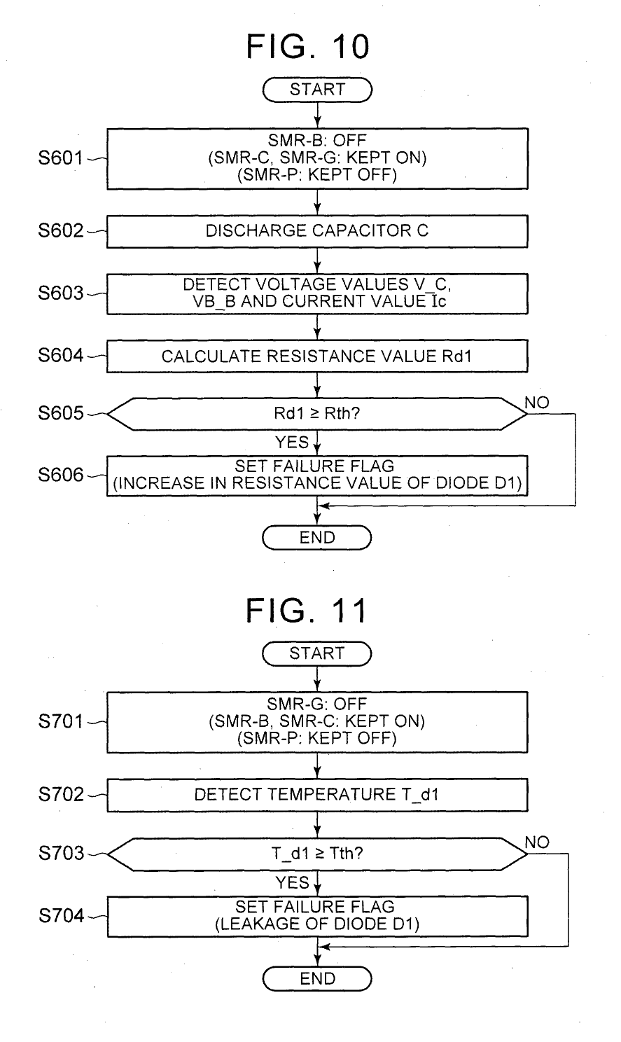

In the processing shown in FIG. 9, although the resistance value Rd1 is calculated based on the voltage value V_C, embodiments are not limited thereto. Specifically, the resistance value Rd1 may be calculated based on the voltage values V_C, VB_A, VB_B. Processing at this time will be described referring to the flowchart of FIG. 10.

For example, when the battery system is switched from the actuation state to the stop state, the processing shown in FIG. 10 can be performed. Here, when starting the processing shown in FIG. 10, the system main relays SMR-B, SMR-C, SMR-G are on. In the following description, although the resistance value Rd1 of the diode D1 is calculated, the same processing may be performed to calculate the resistance value of the diode D2.

Step S601 is the same as Step S501 of FIG. 9. In Step S602, the controller 40 discharges the capacitor C. The capacitor C may be discharged such that a current flows to the load connected to the capacitor C. That is, current application to the load may be performed. In Step S603, the controller 40 detects the voltage values V_C, VB_B using the voltage sensors 21, 23 and detects the current value Ic using the current sensor 25.

In Step S604, the controller 40 calculates the resistance value Rd1 of the diode D1 based on the detection results (voltage values V_C, VB_B and current value Ic) of Step S603. Here, the resistance value Rd1 of the diode D1 can be calculated based on Expression (2).

$$Rd 1 = \frac{VB\_B - V\_C}{Ic} \qquad ( 2 )$$

When the capacitor C is not discharged, the voltage values V_C, VB_B become equal to each other. When the capacitor C is discharged, the voltage value V_C decreases according to the resistance value Rd1 of the diode D1. For this reason, the resistance value Rd1 of the diode D1 can be calculated based on Expression (2). Steps S605 and S606 are the same as Steps S506 and S507 of FIG. 9.

The resistance value Rd1 of the diode D1 may be calculated based on Expression (3) or Expression (4).

$$\begin{matrix}Rd 1 = \frac{ΔVB\_B - ΔV\_C}{Δ Ic} & ( 3 ) \\ Rd 1 = \frac{ΔVB\_B - ΔV\_C}{Ic} & ( 4 )\end{matrix}$$

In Expressions (3) and (4), the capacitor C is discharged with different current values Ic (referred to as Ic1, Ic2). Here, the capacitor C is discharged in an order of the current value Ic1 and the current value Ic2.

In Expressions (3) and (4), the voltage difference ΔVB_B is the difference between the voltage value VB_B when the capacitor C is discharged with the current value Ic1 and the voltage value VB_B when the capacitor C is discharged with the current value Ic2. The voltage difference ΔV_C is the difference between the voltage value V_C when the capacitor C is discharged with the current value Ic1 and the voltage value V_C when the capacitor C is discharged with the current value Ic2.

In Expression (3), the current values Ic1, Ic2 are greater than 0 [A]. The current difference ΔIc in Expression (3) is the difference between the current values Ic1, Ic2. In Expression (4), the current value Ic1 is greater than 0 [A], and the current value Ic2 is 0 [A]. The current value Ic in Expression (4) is the current value Ic1.

Next, processing for determining leakage of the diode D1 will be described referring to the flowchart of FIG. 11. The processing shown in FIG. 11 is executed by the controller 40. For example, when the battery system is switched from the actuation state to the stop state, the processing shown in FIG. 11 can be performed. Here, when starting the processing shown in FIG. 11, the system main relays SMR-B, SMR-C, SMR-G are on, and the system main relay SMR-P is off.

In Step S701, the controller 40 switches off the system main relay SMR-G. The system main relays SMR-B, SMR-C are kept on, and the system main relay SMR-P is kept off. With this, only the battery group 10A can be discharged. In Step S702, the controller 40 detects the temperature T_d1 of the diode D1 using the temperature sensor 26a.

In Step S703, the controller 40 determines whether or not the temperature T_d1 detected in Step S702 is equal to or higher than a predetermined temperature Tth. When the temperature T_d1 is equal to or higher than the predetermined temperature Tth, in Step S704, the controller 40 determines that leakage of the diode D1 occurs, and sets a failure flag. when the temperature T_d1 is lower than the predetermined temperature Tth, the controller 40 determines that leakage of the diode D1 does not occur and ends the processing shown in FIG. 11.

When leakage of the diode D1 does not occur, the discharge current of the battery group 10A does not flow to the diode D1 and flows to the diode D2. When leakage of the diode D1 occurs, the discharge current of the battery group 10A flows to the diode D1. That is, in a current path including the positive electrode line PL, the diode D1, and the intermediate line CL1, the discharge current of the battery group 10A flows.

With this, the diode D1 generates heat. Accordingly, it is determined whether or not the temperature T_d1 is equal to or higher than the predetermined temperature Tth, whereby it can be determined whether or not leakage of the diode D1 occurs. The predetermined temperature Tth can be appropriately set considering the amount of heat generated according to leakage of the diode D1.

Even when determining leakage of the diode D2, the same processing as the processing shown in FIG. 11 can be performed. Specifically, in Step S701 of FIG. 11, the controller 40 switches off the system main relay SMR-B. Then, when the temperature T_d2 of the diode D2 detected by the temperature sensor 26b is equal to or higher than the predetermined temperature Tth, the controller 40 can determine that leakage of the diode D2 occurs.

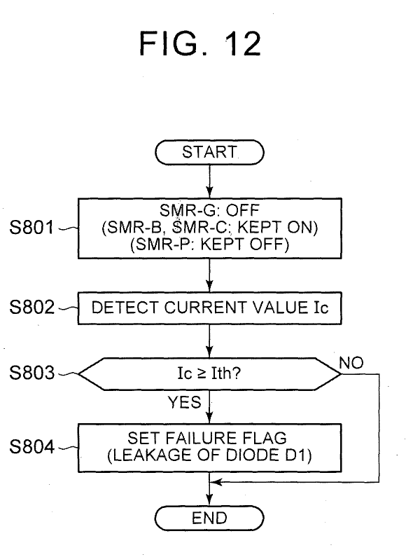

Leakage of the diodes D1, D2 can be determined based on the current value Ic detected by the current sensor 25. This processing will be described referring to the flowchart of FIG. 12. The processing shown in FIG. 12 is executed by the controller 40. For example, when the battery system is switched from the actuation state to the stop state, the processing shown in FIG. 12 can be performed. Here, when starting the processing shown in FIG. 12, the system main relays SMR-B, SMR-C, SMR-G are on, and the system main relay SMR-P is off.

Step S801 is the same as Step S701 of FIG. 11. In Step S802, the controller 40 detects the current value Ic using the current sensor 25. The current value Ic is a current value when current application to the load is not performed. In Step S803, the controller 40 determines whether or not the current value Ic detected in Step S802 is equal to or greater than a predetermined value Ith.

When the current value Ic is equal to or greater than the predetermined value Ith, in Step S804, the controller 40 determines that leakage of the diode D1 occurs, and sets a failure flag. When the current value Ic is less than the predetermined value Ith, the controller 40 determines that leakage of the diode D1 does not occur and ends the processing shown in FIG. 12.

When the capacitor C is not discharged, in other words, when current application to the load is not performed, the voltage value V_C of the capacitor C becomes the voltage value VB_A. In this state, the current value Ic when leakage of the diode D1 occurs is greater than the current value Ic when leakage of the diode D1 does not occur. The predetermined value Ith is set considering this point, and when the current value Ic is equal to or greater than the predetermined value Ith, it can be determined that leakage of the diode D1 occurs.

When determining leakage of the diode D2, the same processing as the processing shown in FIG. 12 can be performed. Specifically, in Step S801 of FIG. 12, the controller 40 may switch off the system main relay SMR-B.

When determining a failure (disconnection or increase in resistance value) in the diode D1, a current may be made to flow in a current path in which current application to the diode D1 is performed. Specifically, the discharge current of the battery group 10B can be made to flow to the diode D1 using the intermediate line CL1. Similarly, when determining a failure (disconnection or increase in resistance value) in the diode D2, a current may be made to flow in a current path in which current application to the diode D2 is performed. Specifically, the discharge current of the battery group 10A may be made to flow to the diode D2 using the intermediate line CL1.

When determining failures (disconnection or increase in resistance value) in the diodes D1, D2, considering the above-described point, the controller 40 may control the on and off of the system main relays SMR-B, SMR-C, SMR-G, SMR-P. Even in the configuration shown in FIG. 4, if the on and off of the system main relays SMR-B, SMR-C, SMR-G, SMR-P are controlled such that a current flows to at least one diode, it is possible to determine failures (disconnection or increase in resistance value) in the diodes. In the configuration shown in FIG. 4, although a current may flow to a plurality of diodes, a failure (disconnection or increase in resistance value) in any one of a plurality of diodes can be determined.

When determining a failure (short-circuiting or leakage) in the diode D1, it should suffice that the battery group 10A connected in parallel to the diode D1 can be discharged. Similarly, when determining a failure (short-circuiting or leakage) in the diode D2, it should suffice that the battery group 10B connected in parallel to the diode D2 can be discharged. When determining failures (short-circuiting or leakage) in the diodes D1, D2, considering the above-described point, the controller 40 may control the on and off of the system main relays SMR-B, SMR-C, SMR-G, SMR-P. Even in the configuration shown in FIG. 4, if each battery group can be discharged, it is possible to determine a failure (short-circuiting or leakage) in a diode connected in parallel to the battery group.

When the above-described failure flag is set, a warning can be performed. As means for a warning, as well known in the art, display on a display or output of sound may be used. When the failure flag is set, the controller 40 may not perform the charging or discharging of the assembled battery 10. For example, the controller 40 can prevent the battery system from being actuated.

A battery system according to Example 3 will be described. In this example, the same components as the components described in Example 1 are represented by the same reference numerals, and detailed description will be omitted. In this example, failures (disconnection) in the diodes D1, D2 described in Example 1 and failures in the system main relays SMR-B, SMR-G, SMR-C are determined. Hereinafter, a difference from Example 1 will be described. The failures in the system main relays SMR-B, SMR-G, SMR-C include a failure in which a relay is kept on and a failure in which a relay is kept off.

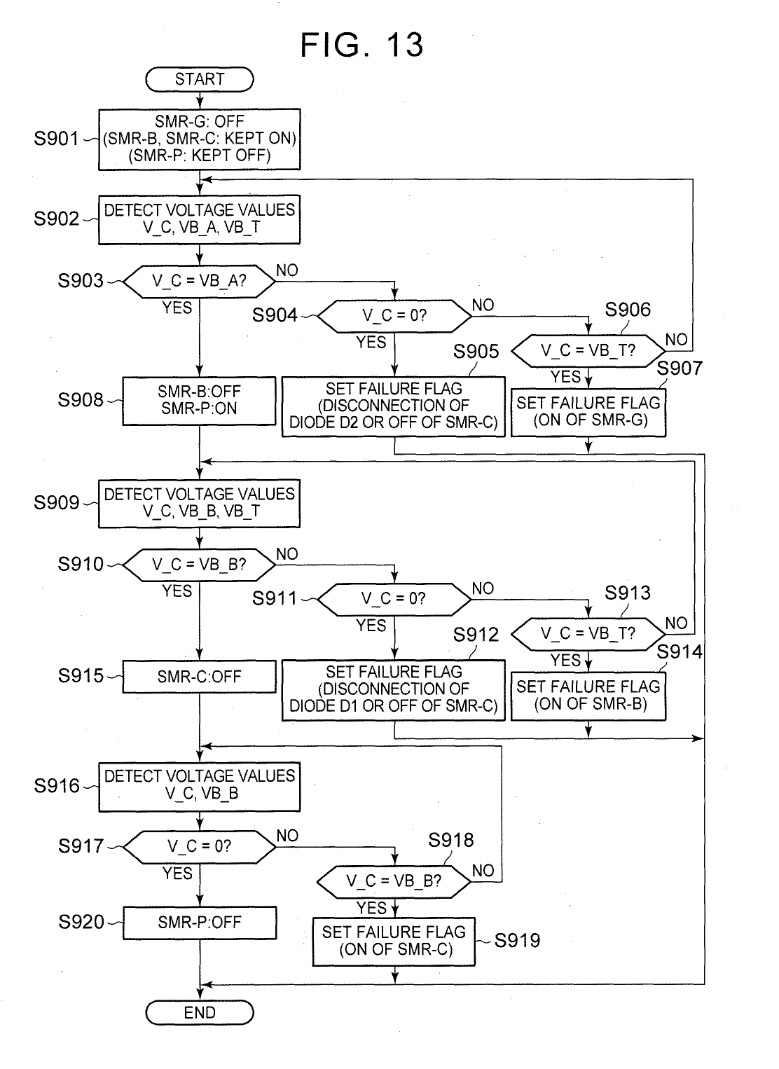

Processing of this example will be described referring to the flowchart of FIG. 13. The processing shown in FIG. 13 is executed by the controller 40. The processing shown in FIG. 13 is performed when the battery system is switched from the actuation state to the stop state. Here, when starting the processing shown in FIG. 13, the system main relays SMR-B, SMR-C, SMR-G are on, and the system main relay SMR-P is off.

In Step S901, the controller 40 outputs a control signal for switching off the system main relay SMR-G. The system main relays SMR-B, SMR-C are kept on, and the system main relay SMR-P is kept off. If the system main relay SMR-G operates in response to the control signal from the controller 40, only the battery group 10A can be discharged. In Step S902, the controller 40 detects the voltage values V_C, VB_A, VB_T using the voltage sensors 21, 22, 24.

In Step S903, the controller 40 determines whether or not the voltage value V_C detected in Step S902 is equal to the voltage value VB_A. Here, considering the detection errors of the voltage sensors 21, 22, it may be determined whether or not the voltage value V_C falls within the range of the detection error based on the voltage value VB_A. When the voltage values V_C, VB_A are different, in Step S904, the controller 40 determines whether or not the voltage value V_C is 0 [V]. Here, considering the detection error of the voltage sensor 21, it may be determined whether or not the voltage value V_C falls within the range of the detection error based on 0 [V].

When the voltage value V_C is 0 [V], in Step S905, the controller 40 determines whether disconnection of the diode D2 occurs or the system main relay SMR-C has a failure in the off state, and sets a failure flag. As described above, although the battery group 10A can be discharged, it can be understood that, if the voltage value V_C is 0 [V], the current path between the battery group 10A and the capacitor C is broken. In this current path, the diode D2 or the system main relay SMR-C is disposed. Accordingly, it can be determined that a failure in the diode D2 or the system main relay SMR-C will occur.

In Step S904, when the voltage value V_C is not 0 [V], in Step S906, the controller 40 determines whether or not the voltage value V_C is equal to the voltage value VB_T. Here, considering the detection errors of the voltage sensors 21, 24, it may be determined whether or not the voltage value V_C falls within the range of the detection error based on the voltage value VB_T. When the voltage value V_C is equal to the voltage value VB_T, in Step S907, the controller 40 determines that the system main relay SMR-G has a failure in the on state.

As described above, although only the battery group 10A is discharged, when the voltage value V_C is equal to the voltage value VB_T, it can be determined that the system main relay SMR-G is kept on. Here, if the system main relay SMR-G is on, the voltage value VB_T is detected by the voltage sensor 24. When the voltage values V_C, VB_T are different, the controller 40 returns to Step S902. In Step S903, when the voltage value V_C is equal to the voltage value VB_A, in Step S908, the controller 40 outputs a control signal for switching off the system main relay SMR-B and a control signal for switching on the system main relay SMR-P. If the system main relays SMR-B, SMR-P operate in response to the control signals from the controller 40, only the battery group 10B can be discharged.

In Step S909, the controller 40 detects the voltage values V_C, VB_B, VB_T using the voltage sensors 21, 23, 24. Here, before detecting the voltage values V_C, VB_B, VB_T, the controller 40 discharges the capacitor C. In Step S910, the controller 40 determines whether or not the voltage value V_C is equal to the voltage value VB_B based on the detection result of Step S909. Here, considering the detection errors of the voltage sensors 21, 23, it may be determined whether or not the voltage value V_C falls within the range of the detection error based on the voltage value VB_B.

When the voltage values V_C, VB_B are different, in Step S911, the controller 40 determines whether or not the voltage value V_C is 0 [V]. Here, considering the detection error of the voltage sensor 21, it may be determined whether or not the voltage value V_C falls within the range of the detection error based on 0 [V]. When the voltage value V_C is 0 [V], in Step S912, the controller 40 determines that disconnection of the diode D1 occurs or the system main relay SMR-C has a failure in the off state, and sets a failure flag.

As described above, although the battery group 10B can be discharged, it can be understood that, when the voltage value V_C is 0 [V], the current path between the battery group 10B and the capacitor C is broken. In this current path, the diode D1 and the system main relay SMR-C are disposed. Accordingly, it can be determined that a failure in the diode D1 or the system main relay SMR-C will occur.

In Step S911, when the voltage value V_C is not 0 [V], in Step S913, the controller 40 determines whether or not the voltage value V_C is equal to the voltage value VB_T. Here, considering the detection errors of the voltage sensors 21, 24, it may be determined whether or not the voltage value V_C falls within the range of the detection error based on the voltage value VB_T. When the voltage value V_C is equal to the voltage value VB_T, in Step S914, the controller 40 determines that the system main relay SMR-B is fixed in the on state, and sets a failure flag.

As described above, although only the battery group 10B can be discharged, when the voltage value V_C is equal to the voltage value VB_T, it can be determined that the assembled battery 10 is discharged. That is, in Step S908, the system main relays SMR-P, SMR-C are on. Accordingly, it can be determined that the system main relay SMR-B is on. Here, if the system main relay SMR-B is on, the voltage value VB_T is detected by the voltage sensor 24. In Step S913, when the voltage values V_C, VB_T are different, the controller 40 returns to Step S909.

In Step S910, when the voltage values V_C, VB_B are equal, in Step S915, the controller 40 outputs a control signal for switching off the system main relay SMR-C. If the system main relay SMR-C operates in response to the control signal from the controller 40, the assembled battery 10 (each of the battery groups 10A, 10B) is not discharged.

In Step S916, the controller 40 detects the voltage values V_C, VB_B using the voltage sensors 21, 23. In Step S917, the controller 40 determines whether or not the voltage value V_C detected in Step S916 is 0 [V]. Here, considering the detection error of the voltage sensor 21, it may be determined whether or not the voltage value V_C falls within the range of the detection error based on 0 [V].

When the voltage value V_C is not 0 [V], in Step S918, the controller 40 determines whether or not the voltage values V_C, VB_B detected in Step S916 are equal. Here, considering the detection errors of the voltage sensors 21, 23, it may be determined whether or not the voltage value V_C falls within the range of the detection error based on the voltage value VB_B. When the voltage values V_C, VB_B are different, the controller 40 returns to Step S916.

When the voltage values V_C, VB_B are equal, in Step S919, the controller 40 determines that the system main relay SMR-C has a failure in the on state, and sets a failure flag. As described above, although the assembled battery 10 (each of the battery groups 10A, 10B) cannot be discharged, it can be understood that, when the voltage values V_C, VB_B are equal, the battery group 10B is discharged. Here, when Step S915 ends, only the system main relay SMR-P is on. For this reason, it can be understood that the system main relay SMR-C is on, and the battery group 10B is discharged. If the system main relay SMR-C is on, the voltage value VB_B is detected by the voltage sensor 23.

In Step S917, when the voltage value V_C is 0 [V], in Step S920, the controller 40 outputs a control signal for switching off the system main relay SMR-P. If the system main relay SMR-P operates in response to the control signal from the controller 40, all system main relays SMR-B, SMR-C, SMR-G, SMR-P are off, and the battery system is stopped.

According to this example, it can be determined whether or not the failures (disconnection) in the diodes D1, D2 will occur, or it can be determined whether or not failures (failures in the on state) in the system main relays SMR-B, SMR-G, SMR-C will occur. If the system main relays SMR-B, SMR-G, SMR-C have failures in the on state, the assembled battery 10 (battery groups 10A, 10B) is kept connected to the load, and overdischarging or overcharging of the assembled battery 10 occurs. Accordingly, it is necessary to determine that the system main relays SMR-B, SMR-G, SMR-C have failures in the on state.

When the battery system is switched from the stop state to the actuation state, it is possible to determine whether or not the system main relay SMR-P has a failure in the on state. For example, when only the system main relay SMR-B is switched on, the controller 40 detects the voltage values V_C, VB_T using the voltage sensors 21, 24. Then, if the voltage values V_C, VB_T are equal, the controller 40 determines that the system main relay SMR-P has a failure in the on state.

When only the system main relay SMR-C is switched on, the controller 40 detects the voltage values V_C, VB_B using the voltage sensors 21, 23. Then, if the voltage values V_C, VB_B are equal, the controller 40 determines that the system main relay SMR-P has a failure in the on state. When it is determined that the system main relay SMR-P has a failure, the controller 40 sets a failure flag.

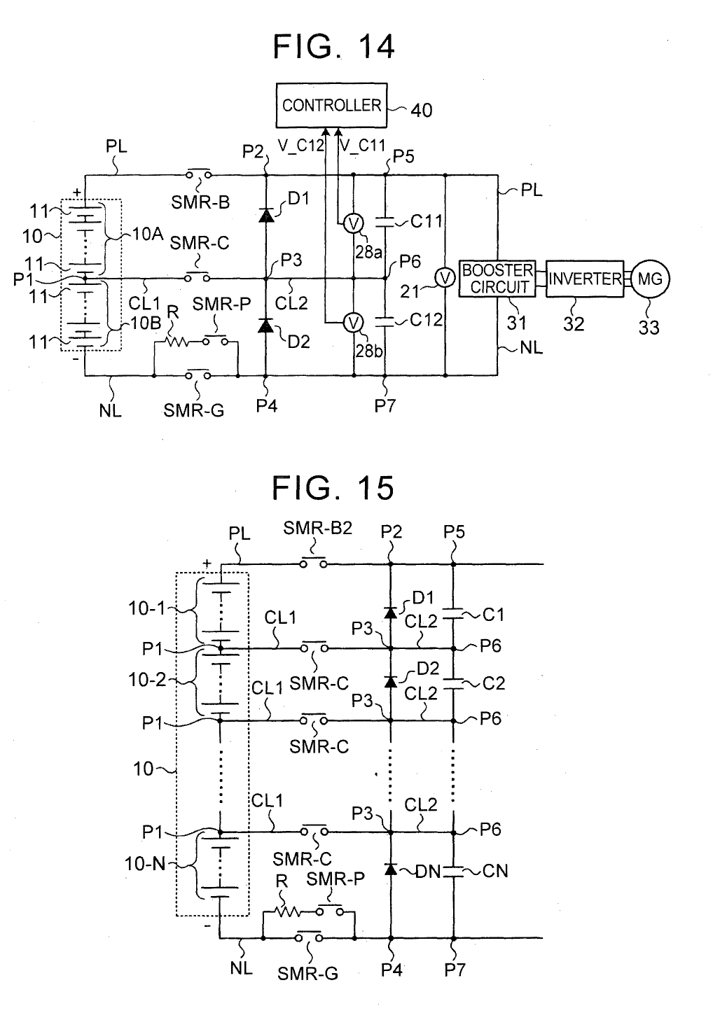

A battery system according to Example 4 will be described referring to FIG. 14. In this example, the same components as the components described in Example 1 are represented by the same reference numerals, and detailed description will be omitted. Hereinafter, a difference from Example 1 will be described. In FIG. 14, a part (air conditioner 34 and the like) of the configuration shown in FIG. 1 is omitted.

In this example, two capacitors C11, C12 are connected in series between the positive electrode line PL and the negative electrode line NL. The capacitors C11, C12 have the same function as the capacitor C described in Example 1. That is, in this example, the capacitor (corresponding to a capacitor unit of some embodiments) C described in Example 1 is constituted by the two capacitors C11, C12.

One end of the capacitor C11 is connected to the positive electrode line PL at a connection point P5. Here, the connection point P2 is positioned between the positive electrode terminal of the assembled battery 10 and the connection point P5 on the positive electrode line PL. One end of an intermediate line (corresponding to a second intermediate line of some embodiments) CL2 is connected to a connection point P3 of diodes D1, D2, and the other end of the intermediate line CL2 is connected to a connection point P6 of the capacitors C11, C12. One end of the capacitor C12 is connected to the negative electrode line NL at a connection point P7. Here, a connection point P4 is positioned between the negative electrode terminal of the assembled battery 10 and the connection point P7 on the negative electrode line NL.

The capacitor C11 is connected in parallel to the battery group 10A or the diode D1 through the positive electrode line PL and the intermediate lines CL1, CL2. The capacitor C12 is connected in parallel to the battery group 10B or the diode D2 through the negative electrode line NL and the intermediate lines CL1, CL2. A voltage sensor 28a detects a voltage value V_C11 of the capacitor C11 and outputs the detection result to the controller 40. A voltage sensor 28b detects a voltage value V_C12 of the capacitor C12 and outputs the detection result to the controller 40.

In this example, as in Example 1, it is possible to decrease the voltage value to be applied to the activated current breaker 11b. Hereinafter, a case where the current breaker 11b of the single battery 11 (arbitrary one) included in the battery group 10A is actuated will be described. A behavior when the current breaker 11b of the single battery 11 (arbitrary one) included in the battery group 10B is activated is the same as a behavior when the current breaker 11b of the single battery 11 included in the battery group 10A is activated, and thus, detailed description will be omitted.

First, a case where the current breaker 11b is activated before actuating the battery system shown in FIG. 14 will be described.

Before actuating the battery system, the capacitors C11, C12 are discharged, and the voltage values V_C11, V_C12 of the capacitors C11, C12 are 0 [V]. If the battery system is actuated, only the battery group 10B is discharged. The discharge current of the battery group 10B flows to the capacitors C11, C12 through the diode D1. With this, the total sum of the voltage values V_C11, V_C12 becomes the voltage value VB_B. At this time, the positive electrode terminal and the negative electrode terminal of the battery group 10A are at the same potential, and the voltage value VB_A of the battery group 10A becomes 0 [V]. Accordingly, the electromotive voltage of the battery group 10A is applied to the activated current breaker 11b. Therefore, as in Example 1, it is possible to decrease the voltage value to be applied to the activated current breaker 11b.

Next, a case where the current breaker 11b is activated when power is supplied to the load will be described.

The current breaker 11b is activated, whereby the battery group 10A is not discharged and only the battery group 10B is discharged. With this, the discharge current of the battery group 10B flows to the capacitors C11, C12 through the diode D1, and the total sum of the voltage values V_C11, V_C12 becomes equal to the voltage value VB_B. At this time, the positive electrode terminal and the negative electrode terminal of the battery group 10A are at the same potential, and the voltage value VB_A of the battery group 10A becomes 0 [V]. Accordingly, the electromotive voltage of the battery group 10A is applied to the activated current breaker 11b. With this, as in Example 1, it is possible to decrease the voltage value to be applied to the activated current breaker 11b.

Next, a case where the current breaker 11b is activated when the assembled battery 10 is charged will be described.

If the current breaker 11b is activated, the battery group 10A cannot be charged. A current (charge current) when charging the assembled battery 10 flows to the capacitors C11, C12, and the capacitors C11, C12 are charged. Furthermore, the battery group 10B is connected in parallel to the capacitor C12 through the intermediate lines CL1, CL2. Accordingly, the charge current also flows to the battery group 10B through the intermediate lines CL1, CL2, and the battery group 10B is charged. Here, since the capacitor C12 and the battery group 10B are connected in parallel, the voltage values V_C12, VB_B become equal to each other.

The charge current flows to the battery group 10B and the capacitor C12, whereby it is possible to suppress an increase in the voltage value of the capacitor C12 compared to a case where the charge current flows only to the capacitor C12. Normally, the capacity of the battery group 10B is greater than the capacity of each of the capacitors C11, C12. Accordingly, the increase amounts of the voltage values VB_B, V_C12 when the charge current flows to the battery group 10B and the capacitor C12 are less than the increase amount of the voltage value V_C11 when the charge current flows to the capacitor C11. With this, it is possible to suppress an increase in the total sum (that is, the voltage value V_C detected by the voltage sensor 21) of the voltage values V_C11, V_C12. In this way, if an increase in the voltage value V_C is suppressed, it is possible to decrease the voltage value to be applied to the load (an electric element included in the booster circuit 31 or the inverter 32).

A voltage value corresponding to the difference between the voltage values VB_A, V_C11 is applied to the activated current breaker 11b. As described above, since the battery group 10A is not charged, the voltage value VB_A is not changed. Since the charge current flows to the capacitor C11, the voltage value V_C11 increases. The more the voltage value V_C11 increases, the greater the voltage value to be applied to the activated current breaker 11b.

Here, as in Example 1 (FIG. 3), when the voltage value V_C11 detected by the voltage sensor 28a is higher than the upper limit voltage value V_ov11, the controller 40 stops power supply to the capacitor C11. With this, it is possible to maintain the voltage value V_C11 at a voltage value equal to or less than the upper limit voltage value V_ov11. If the voltage value V_C11 is maintained at a voltage value equal to or less than the upper limit voltage value V_ov11, a voltage value corresponding to the difference between the voltage value VB_A and the upper limit voltage value V_ov11 is applied to the activated current breaker 11b. With this, it is possible to decrease the voltage value to be applied to the activated current breaker 11b compared to a case where the voltage value V_C11 is greater than the upper limit voltage value V_ov11.

In this example, although the diodes D1, D2 are used, Zener diodes D1, D2 may be used instead of the diodes D1, D2. As described in Example 1, the voltage value V_C11 of the capacitor C11 is equal to or less than the breakdown voltage value of the Zener diode D1. The voltage value V_C12 of the capacitor C12 becomes equal to or less than the breakdown voltage value of the Zener diode D2. With this, it is possible to prevent the voltage values V_C11, V_C12 from excessively increasing, and as described above, it is possible to decrease the voltage value to be applied to the activated current breaker 11b. The Zener diodes D1, D2 are used, whereby it is possible to stop the charging of the capacitors C11, C12 even if power supply to the capacitors C11, C12 is not stopped.

In this example, as in Example 1, the assembled battery 10 can be divided into three or more battery groups 10-1 to 10-N. In this case, as shown in FIG. 15, capacitors C1 to CN can be respectively connected in parallel to the battery groups 10-1 to 10-N and diodes D1 to DN.

In the configuration shown in FIG. 15, although a resistor element R and a system main relay SMR-P are connected in parallel to a system main relay SMR-G, embodiments are not limited thereto. That is, the resistor element R and the system main relay SMR-P may be connected in parallel to at least one of system main relays SMR-B, SMR-C, SMR-G. Here, as described in Example 1, considering that a rush current to the capacitors C1 to CN is suppressed, the positions where the resistor element R and the system main relay SMR-P are provided can be determined.

In this example, the same processing as in Example 2 is performed, whereby it is possible to determine failures (disconnection, short-circuiting, increase in resistance value, leakage) in the diodes D1, D2.

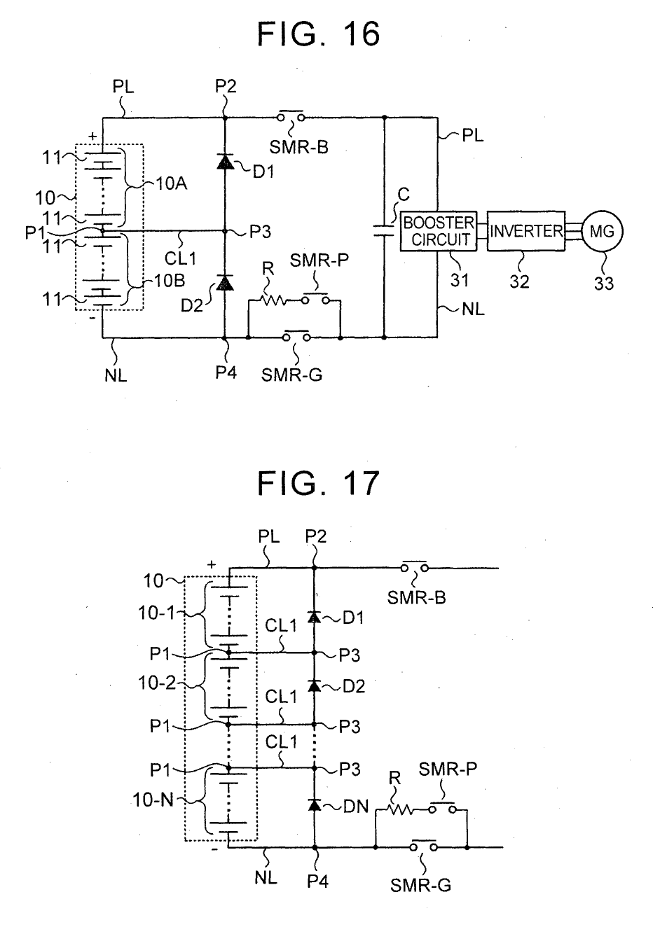

A battery system according to Example 5 will be described referring to FIG. 16. In this example, the same components as the components described in Example 1 are represented by the same reference numerals, and detailed description will be omitted. Hereinafter, a difference from Example 1 will be described.

In this example, the diodes D1, D2 are connected in series between the positive electrode line PL and the negative electrode line NL. Here, the cathode of the diode D1 is connected to the positive electrode line PL positioned between the assembled battery 10 and the system main relay SMR-B. That is, the connection point P2 of the diode D1 and the positive electrode line PL is positioned between the positive electrode terminal of the assembled battery 10 and the system main relay SMR-B on the positive electrode line PL.

The anode of the diode D1 is connected to the cathode of the diode D2, and the other end of the intermediate line CL1 is connected to the connection point P3 of the diodes D1, D2. The anode of the diode D2 is connected to the negative electrode line NL positioned between the assembled battery 10 and the system main relay SMR-G. That is, the connection point P4 of the diode D2 and the negative electrode line NL is positioned between the negative electrode terminal of the assembled battery 10 and the system main relay SMR-G on the negative electrode line NL.

The system main relay SMR-C described in Example 1 is not provided in the intermediate line CL1. In this example, as in Example 1, it is possible to decrease the voltage value to be applied to the activated current breaker 11b. Furthermore, Zener diodes D1, D2 can be used instead of the diodes D1, D2 shown in FIG. 16.

A fuse (the fuse 27 shown in FIG. 5) can be provided in the intermediate line CL1. With this, for example, when a failure (short-circuiting or leakage) in the diode D1 occurs, the fuse can be melted, thereby preventing the battery group 10A from being continuously discharged. When a failure (short-circuiting or leakage) in the diode D2 occurs, the fuse can be melted, thereby preventing the battery group 10B from being continuously discharged.

As shown in FIG. 17, the assembled battery 10 can be divided into three or more battery groups 10-1 to 10-N. Here, diodes D1 to DN are respectively connected in parallel to the battery groups 10-1 to 10-N. A fuse can also be provided in each intermediate line CL1 shown in FIG. 17.

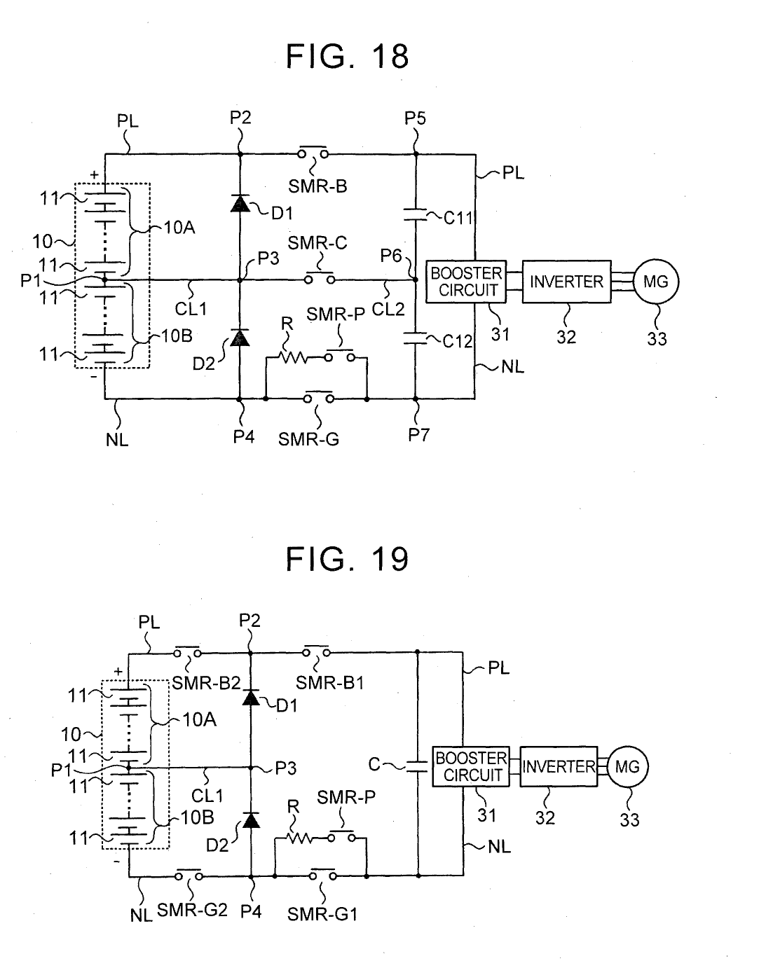

A modification example of this example will be described referring to FIG. 18. In a configuration shown in FIG. 18, an intermediate line CL2 is added to the configuration shown in FIG. 16, and capacitors C11, C12 are connected in series between the positive electrode line PL and the negative electrode line NL. One end of the intermediate line CL2 is connected to the connection point P3 of the diodes D1, D2, and the other end of the intermediate line CL2 is connected to the connection point P6 of the capacitors C11, C12. A system main relay SMR-C is provided in the intermediate line CL2. A system main relay SMR-C may not be provided in the intermediate line CL2. The capacitors C11, C12 are respectively connected in parallel to the diodes D1, D2, whereby it is possible to obtain the same effects as in Example 4 (the configuration shown in FIG. 14).

In the configuration shown in FIG. 18, the assembled battery 10 may be divided into three or more battery groups. In this case, similarly to FIG. 15, a diode and a capacitor may be connected in parallel to each battery group. Specifically, similarly to FIG. 17, the intermediate line CL1 is used, whereby each diode can be connected in parallel to each battery group. Similarly to FIG. 18, the intermediate line CL2 is used, whereby each capacitor can be connected in parallel to each diode. Here, similarly to FIG. 18, a system main relay SMR-C can be provided in the intermediate line CL2.

A battery system according to Example 6 will be described referring to FIG. 19. In this example, the same components as the components described in Example 1 are represented by the same reference numerals, and detailed description will be omitted. Hereinafter, a difference from Example 5 will be described.

In the battery system shown in Example 5 (FIGS. 16 to 18), when the current breaker 11b is not activated, no current flows to the diodes D1, D2. If no current flows to the diodes D1, D2, as described in Example 2, it is not possible to determine failures in the diodes D1, D2. Accordingly, in this example, a current can be made to flow to each of the diodes D1, D2.

In FIG. 19, system main relays SMR-B1, SMR-B2 are provided in the positive electrode line PL. The system main relays SMR-B1, SMR-B2 are switched between on and off in response to a control signal from the controller 40. One end of the system main relay SMR-B2 is connected to the positive electrode terminal of the assembled battery 10, and the other end of the system main relay SMR-B2 is connected to one end of the system main relay SMR-B1. The cathode of the diode D1 is connected to a connection point of the system main relays SMR-B2, SMR-B1. In other words, the connection point P2 of the diode D1 and the positive electrode line PL is positioned between the system main relays SMR-B2, SMR-B1 on the positive electrode line PL.

System main relays SMR-G1, SMR-G2 are provided in the negative electrode line NL. The system main relays SMR-G1, SMR-G2 are switched between on and off in response to a control signal from the controller 40. One end of the system main relay SMR-G2 is connected to the negative electrode terminal of the assembled battery 10, and the other end of the system main relay SMR-G2 is connected to one end of the system main relay SMR-G1. The anode of the diode D2 is connected to a connection point of the system main relays SMR-G2, SMR-G1. In other words, the connection point P4 of the diode D2 and the negative electrode line NL is positioned between the system main relays SMR-G2, SMR-G1 on the negative electrode line NL.

In the configuration shown in FIG. 19, a fuse (the fuse 27 shown in FIG. 5) can be provided in the intermediate line CL1. With this, when failures (short-circuiting or leakage) in the diodes D1, D2 occur, the fuse can be melted, thereby preventing the battery groups 10A, 10B from being continuously discharged. A system main relay SMR-C may be provided in the intermediate line CL1.

According to the configuration shown in FIG. 19, when the system main relay SMR-B1 and the system main relay SMR-G1 (or the system main relay SMR-P) are on, the system main relays SMR-B2, SMR-G2 are switched between on and off, whereby a current can be made to flow to the diodes D1, D2. Here, if the system main relay SMR-B2 is switched off and the system main relay SMR-G2 is switched on, the discharge current of the battery group 10B can be made to flow to the diode D1. If the system main relay SMR-B2 is switched on and the system main relay SMR-G2 is switched off, the discharge current of the battery group 10A can be made to flow to the diode D2.

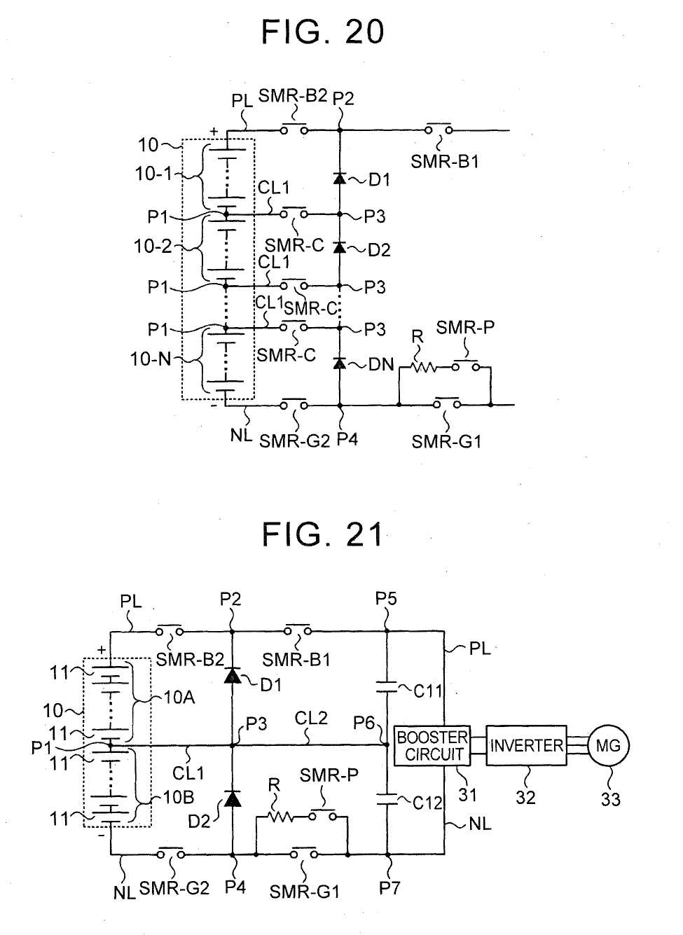

If a current can be made to flow to the diodes D1, D2, as described in Example 2, it is possible to determine failures in the diodes D1, D2. As shown in FIG. 20, the assembled battery 10 may be divided into three or more battery groups 10-1 to 10-N. Here, the diodes D1 to DN are respectively connected in parallel to the battery groups 10-1 to 10-N. The system main relay SMR-C is provided in each intermediate line CL1.

The system main relay SMR-C may not be provided in any arbitrary one intermediate line CL1. Even if the system main relay SMR-C is not provided in any arbitrary one intermediate line CL1, the on and off of the other system main relays SMR-C, SMR-B2, SMR-G2 are controlled, whereby it is possible to make the discharge current of the battery group flow to the diodes D1 to DN. With this, as described in Example 2, it is possible to determine failures in the diodes D1 to DN.

A configuration shown in FIG. 21 may be used. In the configuration shown in FIG. 21, the intermediate line CL2 is added to the configuration shown in FIG. 19, and the capacitors C11, C12 are connected in series between the positive electrode line PL and the negative electrode line NL. One end of the intermediate line CL2 is connected to the connection point P3 of the diodes D1, D2, and the other end of the intermediate line CL2 is connected to the connection point P6 of the capacitors C11, C12. The capacitors C11, C12 are respectively connected in parallel to the diodes D1, D2, whereby it is possible to obtain the same effects as in Example 4 (the configuration shown in FIG. 14).

In the configuration shown in FIG. 21, the assembled battery 10 may be divided into three or more battery groups. In this case, similarly to FIG. 15, a diode and a capacitor may be connected in parallel to each battery group. Specifically, similarly to FIG. 20, the intermediate line CL1 is used, whereby each diode can be connected in parallel to each battery group. Similarly to FIG. 21, the intermediate line CL2 is used, whereby each capacitor can be connected in parallel to each diode.

In this example, the same processing as in Example 2 is performed, whereby it is possible to determine failures (disconnection, short-circuiting, increase in resistance value, leakage) in the diodes D1, D2. Here, in FIG. 6 (Step S201), FIG. 8 (Step S401), FIG. 9 (Step S501), and FIG. 10 (Step S601), the system main relay SMR-B2 is used instead of the system main relay SMR-B. In FIG. 7 (Step S301), FIG. 11 (Step S701), and FIG. 12 (Step S801), the system main relay SMR-G2 is used instead of the system main relay SMR-G.

What is claimed is:

1. An electricity storage system comprising:
an electricity storage device which is able to supply power to a load, the electricity storage device including at least two electricity storage groups connected in series, each electricity storage group including at least two electricity storage elements connected in series, and each electricity storage element including a current breaker configured to break a current path of the electricity storage element;
a positive electrode line which connects a positive electrode terminal of the electricity storage device to the load;
a negative electrode line which connects a negative electrode terminal of the electricity storage device to the load;
a capacitor which is connected to the positive electrode line and the negative electrode line;
at least two diodes which are connected in series between the positive electrode line and the negative electrode line and are respectively connected in parallel to the electricity storage groups, a cathode of each diode being connected to a positive electrode terminal of each electricity storage group and an anode of each diode being connected to a negative electrode terminal of each electricity storage group; and
a first intermediate line which is connected between a first connection point and a second connection point, the electricity storage groups being connected together at the first connection point and the diodes being connected together at the second connection point.

2. The electricity storage system according to claim 1, further comprising:
at least two capacitors which are connected to the positive electrode line and the negative electrode line and are respectively connected in parallel to the diodes; and
a second intermediate line which is connected between the second connection point and a third connection point, the capacitors being connected together at the third connection point.

3. The electricity storage system according to claim 1, further comprising:
a fuse which is provided in the first intermediate line and is melted by a discharge current of each electricity storage group according to short-circuiting of the diodes.

4. The electricity storage system according to claim 1, further comprising:
a first relay which is provided between the first connection point and the second connection point in the positive electrode line;
a second relay which is provided between the first connection point and the second connection point in the negative electrode line; and
a third relay which is provided in the first intermediate line.

5. The electricity storage system according to claim 1, further comprising:
a voltage sensor configured to detect a voltage value of the capacitor;
a relay configured to make a discharge current of each electricity storage group flow to each of the diodes through the first intermediate line; and
a controller configured to
determine that the diodes have a failure when the voltage value at a time which the relay is driven such that the discharge current flows to each of the diodes is substantially 0.

6. The electricity storage system according to claim 1, further comprising:
a voltage sensor configured to detect a voltage value of the capacitor;
a relay configured to control a current flowing to each of the diodes through the first intermediate line; and
a controller configured to
calculate a decrease amount of the voltage value according to a start of current application to the load with a predetermined current value when the relay is driven such that a discharge current of each electricity storage group flows to each of the diodes, and
determine that the diodes have a failure when the decrease amount is equal to or greater than a predetermined amount.

7. The electricity storage system according to claim 1, further comprising:
a voltage sensor configured to detect a voltage value of the capacitor;
a current sensor configured to detect a current value on the first intermediate line;
a relay configured to control a current flowing to each of the diodes through the first intermediate line; and
a controller configured to
calculate a resistance value of each diode based on a decrease amount of the voltage value at the time of a start of current application to the load and the current value at the time of current application to the load when the relay is driven such that a discharge current of each electricity storage group flows to each of the diodes, and
determine that the diodes have a failure when the resistance value is equal to or greater than a predetermined value.

8. The electricity storage system according to claim 1, further comprising:
a first voltage sensor configured to detect a voltage value of each electricity storage group;
a second voltage sensor configured to detect a voltage value of the capacitor;
a current sensor configured to detect a current value on the first intermediate line;
a relay configured to control a current flowing to each of the diodes through the first intermediate line; and
a controller configured to
calculate a resistance value of each diode based on the voltage value of the capacitor at the time of discharging of the capacitor, a voltage value of a predetermined electricity storage group, and the current value at the time of discharging of the capacitor when the relay is driven such that a discharge current of each electricity storage group flows to each of the diodes, the predetermined electricity storage group being an electricity storage group to be discharged by the driving of the relay, and
determine that the diodes have a failure when the resistance value is equal to or greater than a predetermined value.

9. The electricity storage system according to claim 1, further comprising:
a temperature sensor configured to detect a temperature of each diode;
a relay configured to control a current flowing to each of the diodes through the first intermediate line; and
a controller configured to
determine that the diodes have a failure when the relay is driven such that a discharge current of each electricity storage group flows to each of the diodes and the temperature of a predetermined diode is equal to or higher than a predetermined temperature, the predetermined diode being a diode which is connected in parallel to an electricity storage group to be discharged by the driving of the relay.

10. The electricity storage system according to claim 1, further comprising:
a current sensor configured to detect a current value on the first intermediate line;
a relay configured to control a current flowing to each of the diodes through the first intermediate line; and
a controller configured to
determine that a predetermined diode has a failure when the relay is driven such that a discharge current of each electricity storage group flows to each of the diodes and when the current value at the time of no current application to the load is equal to or greater than a predetermined value, the predetermined diode being a diode which is connected in parallel to the electricity storage group to be discharged by the driving of the relay.

11. The electricity storage system according to claim 1, wherein the diodes are Zener diodes.
